(19) United States
(12) Patent Application Publication
(10) Pub. No.: US 2008/0172327 A1
(43) Pub. Date: Jul. 17, 2008

(54) System and method for monitoring and conducting transactions of objects of value

(75) Inventor: David M. Bohonnon, Madison, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(73) Assignee: Secured Marine Trust, LLC, a limited liability company of the State of Connecticut.

(21) Appl. No.: 10/646,177

(22) Filed: Aug. 22, 2003

Related U.S. Application Data
(60) Provisional application No. 60/405,523, filed on Aug. 23, 2002.
(60) Provisional application No. 60/422,269, filed on Oct. 29, 2002.

(51) Int. Cl. G06F 17/60

(52) U.S. Cl. 705/39

(57) ABSTRACT

A system is provided for tracking and monitoring a transaction of an object of value such as, for example, a yacht, boat, ship, marine vessel, aircraft, motor vehicle, other transportation vehicles and real estate for personal, commercial and/or recreational use. The system includes at least one client device operable by at least one of a plurality of users of the system, at least one centralized data store for storing information that includes data identifying the object of value, the plurality of users of the system, and the transaction, the transaction data including a plurality of activities and documents for completing the transaction and a controller. The controller operatively couples the client device and the centralized data store and selectively provides access to information stored in the data store for tracking and monitoring the transaction and the activities performed and documents created, reviewed and completed by parties to the transaction.

### CROSS-REFERENCE TO RELATED APPLICATIONS

This patent application claims the benefit of U.S. Provisional Patent Applications Ser. No. 60/405,523, entitled “SYSTEM AND METHOD FOR MONITORING AND CONDUCTING TRANSACTIONS OF OBJECTS OF VALUE” that was filed Aug. 23, 2002 and Ser. No. 60/422,269, entitled “SYSTEM AND METHOD FOR MONITORING AND CONDUCTING TRANSACTIONS OF OBJECTS OF VALUE” that was filed on Oct. 29, 2002. The disclosure of these patent documents are incorporated by reference in their entireties as if fully set forth herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates generally to systems and methods for monitoring and conducting transactions regarding objects of value and, in particular, to systems and methods for facilitating workflow (e.g., documents and activities) surrounding a sale of an object of value such as, for example, a yacht, boat, ship, marine vessel, aircraft, motor vehicle, other transportation vehicles and real estate for personal, commercial and/or recreational use.

2. Description of Prior Art

State and other jurisdictional regulations require that certain products and/or service providers be registered, licensed, titled, or certified in accordance with specific requirements. For example, purchasers of certain motor vehicles (e.g., marine vessels, motor vehicles, aircraft, and the like) are required to file appropriate title documents or registration papers with a state agency. In transactions involving aviation and marine equipment, registration and other documentation is also typically provided to federal agencies.

Systems exist for storing information provided in satisfaction of the requirements of the aforementioned registration processes. However, the inventor has found a number of deficiencies in such systems. For example, conventional systems typically provide information to only a few parties of transactions involving such vehicles. That is, manufacturers and consumers purchasing such vehicles and/or equipment used therewith may not be provided access to a number of documents involved in a particular transaction.

Accordingly, the inventor has realized that a need exists for an improved system and method for monitoring and conducting transactions regarding objects of value such as, for example, a yacht, boat, ship, marine vessel, aircraft, motor vehicle, other transportation vehicles and real estate for personal, commercial and/or recreational use, by facilitating and providing visibility to activities and documents involved in the transactions.

### SUMMARY OF THE INVENTION

The present invention provides a system for tracking activities and documents related to the sale of an object of value such as, for example, a yacht, boat, ship, marine vessel, aircraft, motor vehicle, other transportation vehicles and real estate for personal, commercial and/or recreational use. Documents include sale, title, registration and mortgage documentation. The system includes features specifically directed to a number of users of the system, for example, a dealer or broker, an escrow agent, a documentation agent, a buyer, a manufacturer, a floor plan company, retail banks or financial institution, insurance agent/broker, a marine surveyor as well as SMT™ system administrator/closing coordinator.

In one embodiment, the system tracks and monitors a transaction of an object of value such as, for example, a yacht, boat, ship, marine vessel, aircraft, motor vehicle, other transportation vehicles and real estate for personal, commercial and/or recreational use. The system includes at least one client device operable by at least one of a plurality of users of the system, at least one centralized data store for storing information that includes data identifying the object of value, the plurality of users of the system, and the transaction, the transaction data including a plurality of activities and documents for completing the transaction and a controller. The controller operatively couples the client device and the centralized data store and selectively provides access to information stored in the data store for tracking and monitoring the transaction and the activities performed and documents created, reviewed and completed by parties to the transaction. In one embodiment, the system further includes a user interface providing a graphical representation of the transaction and the plurality of activities and documents. Preferably, the graphical representation further includes information regarding a current status of the activities and documents.

### BRIEF DESCRIPTION OF THE DRAWINGS

The features and advantages of the present invention will be better understood when the Detailed Description of the Preferred Embodiments given below is considered in conjunction with the figures provided, wherein:

FIG. 1 is a simplified block diagram of a data processing system constructed and operating in accordance with one embodiment of the present invention;

FIG. 2 is a simplified block diagram of a tiered implementation of the data processing system of FIG. 1;

FIGS. 3A-3G depict application maps of a worldwide web implementation of the data processing system of FIG. 1 in accordance with one embodiment of the present invention;

FIGS. 4A and 4B depict one embodiment of a user interface providing details regarding an object of value involved in a transaction tracked and monitored by the data processing system of FIG. 1;

FIGS. 5A-5C depict one embodiment of a user interface providing details regarding a transaction for the object of value of FIGS. 4A-4B;

FIG. 6 depicts a user interface for displaying a summary of transaction data;

FIGS. 7A and 7B depict a user interface for editing the transaction data of FIG. 6;

FIG. 8 is a user interface for invoking an inquiry into a third party data store including information corresponding to the object of value;

FIGS. 9A and 9B, and 10A-10D depict electronic versions of documents of interest within the transaction regarding the object of value;

FIG. 11 depicts a user interface providing information regarding financial instruments related to the transaction involving the object of value;

FIG. 12 depicts a user interface providing detailed information regarding the financial instrument;

FIG. 13 depicts a user interface providing transactions in services supporting the object of value;

FIGS. 14A and 14B depict an electronic service order related to the object of value;

FIGS. 15A and 15B depict a user interface providing a graphical representation of milestones for completing a transaction involving the object of value;

FIGS. 16A and 16B depict a user interface providing a graphical representation of a document generation routine;

FIGS. 17A-17D depicts data records, in accordance with one embodiment of the present invention, for storing information of objects and transactions tracked and monitored by the present invention;

FIGS. 18A and 18B depict a user interface providing information for a first step of a process of originating a transaction record in accordance with one embodiment of the present invention;

FIGS. 19A-19C depict a user interface providing information for a second step of the originating transaction process;

FIG. 20 depicts a user interface providing information for a third step of the originate transaction process;

FIGS. 21A-21C depict a user interface providing information for a fourth step of the originate transaction process;

FIGS. 22A and 22B depict a user interface providing information for a fifth step of the originate transaction process;

FIG. 23 depicts a user interface providing information for a sixth step of the originate transaction process; FIGS. 24A-24I depict a user interface providing information for a seventh step of the originate transaction process;

FIGS. 25A and 25B depict a user interface providing information for a client approval process invoked by an administrator of the system of FIG. 1;

FIGS. 26A and 26B depict a user interface providing information for transaction maintenance invoked by an administrator of the system of FIG. 1; and

FIGS. 27A and 27B depict a user interface providing information for assisting an administrator of the system of FIG. 1 defining documents of interest within a transaction tracked and monitored by the system.

In these figures, like structures are assigned like reference numerals, but may not be referenced in the description for all figures.

### DETAILED DESCRIPTION OF THE PREFERRED EMBODIMENTS

### System Overview:

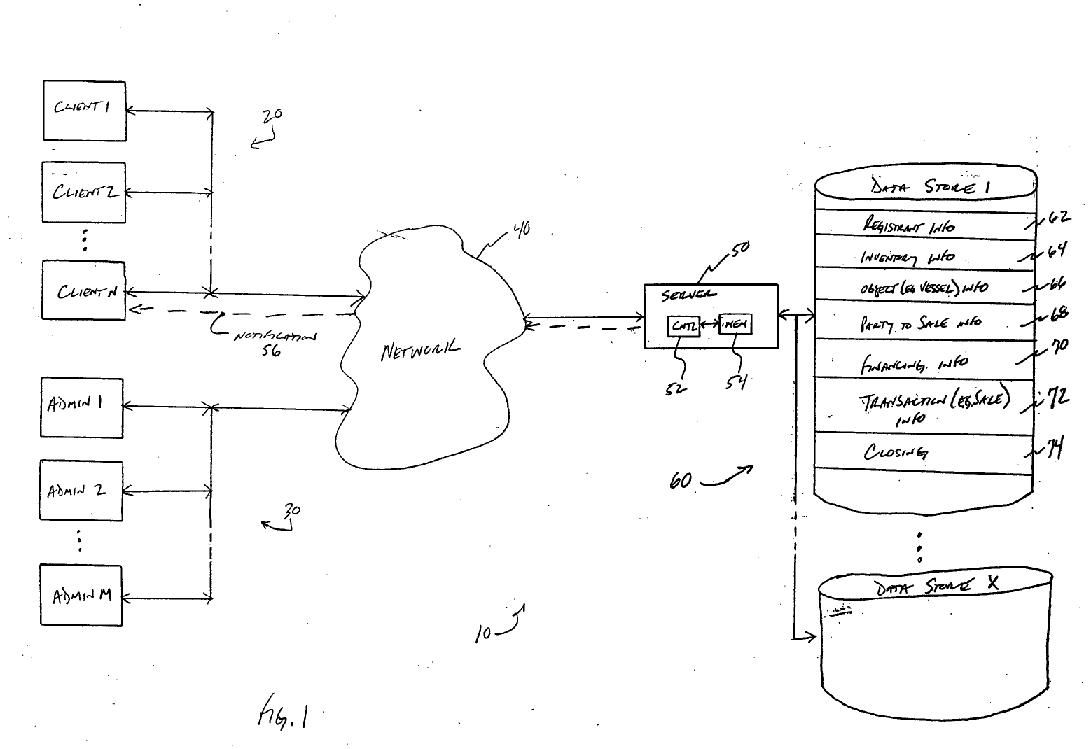

FIG. 1 illustrates a data processing system 10 configured and operating in accordance with one embodiment of the present invention to implement techniques, as described herein, for tracking activities and documents related to transactions (e.g., sale transactions) involving an object of value such as, for example, a yacht, boat, ship, marine vessel, aircraft, motor vehicle, and other transportation vehicles for personal, commercial and/or recreational use whether transporting persons and/or cargo (hereinafter referred to as the SECURED MARINE TRUST™ or SMT™ system 10). SECURED MARINE TRUST and SMT are trademarks of Secured Marine Trust, LLC, of New Haven, Conn. The SMT™ system includes a plurality of client computer systems (Client 1-Client N), shown generally at 20, and a plurality of administration computer systems (Admin 1-Admin M), shown generally at 30. The client computer systems 20 and administration computer systems 30 are coupled to a server system 50 through a communication network 40 such as, for example, the Internet, an intranet or an extranet.

Although not illustrated in FIG. 1, it should be appreciated that the plurality of client computer systems 20 and administration computer systems 30 include remote and/or local computer systems coupled to the communication network 40 over wired or wireless connections. Each of the client and administration computer systems 20 and 30 include an input device and an output device coupled to a processing unit. The input devices include, for example, a keyboard, mouse, touch-sensitive screen, electronic stylus or other conventional input devices for inputting information to the client and administration computer systems 20 and 30. The output devices include, for example, a display device or monitor, a printer or other conventional output devices for receiving and presenting information to users of the client and administration computer system 20 and 30. The processing units include, for example, a personal computer, work station or portable computing device such as a laptop or tablet computer, personal data assistant (PDA), or the like. In some embodiments, the input device, output device and processing unit are incorporated in a single form factor, such as in the aforementioned laptop and PDAs.

In one embodiment, clients operating the client computer systems 20 include brokers, dealers, manufacturers, floor planners, insurance agents and lenders. It should be appreciated that these entities have an interest, for example, a financial interest, in a transaction involving an object of value that is tracked by the SMT™ system 10. As described herein, the SMT™ system 10 monitors and provides visibility to the transaction from a number of perspectives such that information of interest to the above-described clients is available upon request. In one embodiment, milestones such as, for example, activities performed and documents created, reviewed and completed by parties to the transaction, are updated and made available (in real-time) to the parties so that the status of each milestone and progress toward completion of the transaction (e.g., closing) is readily available. As described herein, the SMT™ system 10 is a repository of data and provides features and functions for storing, tracking and monitoring transactions and the activities and documentation included therein.

For clarity, the following discussion assumes the object of value is a marine vessel and the transaction involves a sale of the marine vessel. It should be appreciated, however, that this characterization of a marine vessel sale transaction is illustrative and not intended to limit the scope of the present invention to application and/or transactions involving only sale transactions of marine vessels. Accordingly, it should be appreciated that the present invention is applicable to other objects of value and transactions involving the same. For example, it is within the scope of the present invention to include transactions involving real estate, aviation equipment and aircraft having personal, commercial and recreational uses. In one embodiment, the present invention includes data base management system having multi-functional business applications such as, for example, archive and retrieval facilities (supporting research activities), state, federal or other jurisdictional registration and documentation tools, Multiple Listing Services (MLS), applications supporting anti-terrorism, security and/or compliance initiatives under, for example, the Department of Homeland Security (DHS) and the DHS Vessel Ownership Reference tool, Vessel Warranty Management tool, Dealership/Manufacturer Automation tool, Document Standardization tool (e.g., for banks, insurance and other institutional entities).

System administrators operate the administration computer systems 30 to manage, streamline and safeguard the accuracy and efficient by which the SMT™ system 10 monitors and facilitates transactions.

The server 50 includes a controller 52 such as a microprocessor and a memory device 54 having, for example, ROM, RAM and/or non-volatile memory components for storing application programming logic, variables and/or parameters used during operating of the controller 52. It should be appreciated that the server 50 may be implemented in various configurations and, while not illustrated in FIG. 1, the server 50 may include a plurality of server computer systems at one or more facilities as is known in the art to support, for example, transaction load, improved responsiveness of the system 10, disaster recovery and the like.

As shown in FIG. 1, the server 50 is coupled to a plurality of data stores 60 directly or by means of a data bus as is generally known in the art. It should be appreciated that the data stores 60 may be any type of storage device such as, for example, a magnetic, optical or other non-volatile device for storing digital data. Preferably, the server 50 and data stores 60 are implemented in an Internet-based environment.

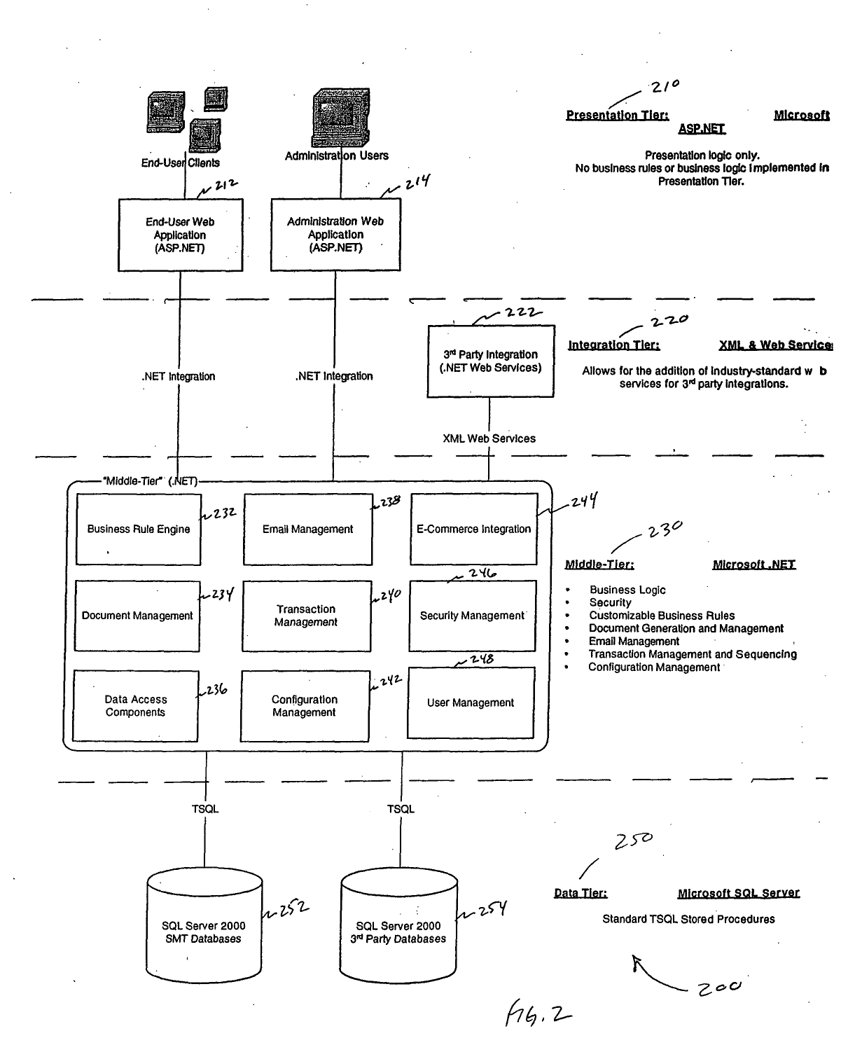

In one embodiment, illustrated in FIG. 2, the SMT™ system 10 is implemented in a tiered approach 200. The tiered approach 200 includes the use of modular functionality to ensure flexibility for modifying existing and adding new features and functions. As shown in FIG. 2, the SMT™ system 10 includes a “front end” or presentation tier 210, an integration tier 220, a middle or command and control tier 230 and a data tier 250.

The presentation tier 210 provides an interface between the server 50 and the client and administration computer systems 20 and 30. In one embodiment, the presentation layer 210 is implemented using the Hypertext Markup Language (HTML) and Active Server Pages (ASPs) on a Microsoft web server or the like. It should be appreciated that no business rules or business logic is implemented in the presentation layer 210. In one embodiment, the presentation layer 210 is a user interface application module 212 including the following components and interfaces:
Registration;
Constituent Transaction Module interfaces, where the constituents are the clients using the SMT™ system 10 (e.g., brokers, dealers, manufacturers, floor planners, insurance agents and lenders). As noted below, the transaction modules are implemented in the command and control tier 230;
COUNTDOWN TO CLOSING^{SM}, which is a transaction tracking mechanism implemented in the command and control tier 230;
VESSEL TRACK^{SM}, which is an interface to third party data bases having detail information regarding a vessel (e.g., registration information maintained by the U.S. Coast Guard, MLS services, industry associations, jurisdictional registration agencies (state, county as well as federal registration agencies, credit bureaus, and contact management systems) and is implemented in the command and control tier 230;
Document management (e.g., pdf document format or similar technology)—with live update, freeze and archive ability, which is implemented in the command and control tier 230;
e-mail triggers which provide notification messages to clients of events of interest within various steps of the transaction and which is implemented in the command and control tier 230;
Interfaces for the constituents;
Search engine, which is implemented in the command and control tier 230;
Integrated context-sensitive help system, which is implemented in the command and control tier 230;
External database connectivity (import/export), which is implemented in the command and control tier 230; and
External resource section (links to 3rd party data and websites), which is implemented in the command and control tier 230.

COUNTDOWN TO CLOSING^{SM} and VESSEL TRACK^{SM} are service marks of Secured Marine Trust, LLC, of New Haven, Conn.

The presentation layer 210 also includes an administration application module 214 having interfaces to the following components:
Security management, which is implemented in the command and control tier 230
User management, which is implemented in the command and control tier 230
Application configuration, which is implemented in the command and control tier 230

The interface tier 220 includes a third party integration module 222, which cooperates with the command and control tier 230 to provide real-time connectivity to, for example, financial institutions transferring funds for a particular transaction, SMT™ system 10 accounting modules and credit bureaus providing information related to approving potential buyers and e-commerce activities. In one embodiment, the command and control tier 230 is implemented using Microsoft Corporation's (Redmond, Wash.) .NET technology and the data tier 250 is implemented using Microsoft's SQL Server 2000 technology as are generally known in the art. In one embodiment, the interface tier 220 is utilized to permit data sharing between the SMT™ system 10 and systems within constituent facilities (e.g., data sharing with loan processing systems of financial institutions that are clients of the SMT™ system 10).

As illustrated in FIG. 2, the command and control tier 230 includes a business rules engine 232, document management 234, data access components 236, email management 238, transaction management 240, configuration management 242, e-commerce integration 244, security management 246, user management 248. The modules cooperate and coordinate with modules in the presentation tier 210 and data tier 250 to provide the SMT™ system 10 functionality as described herein.

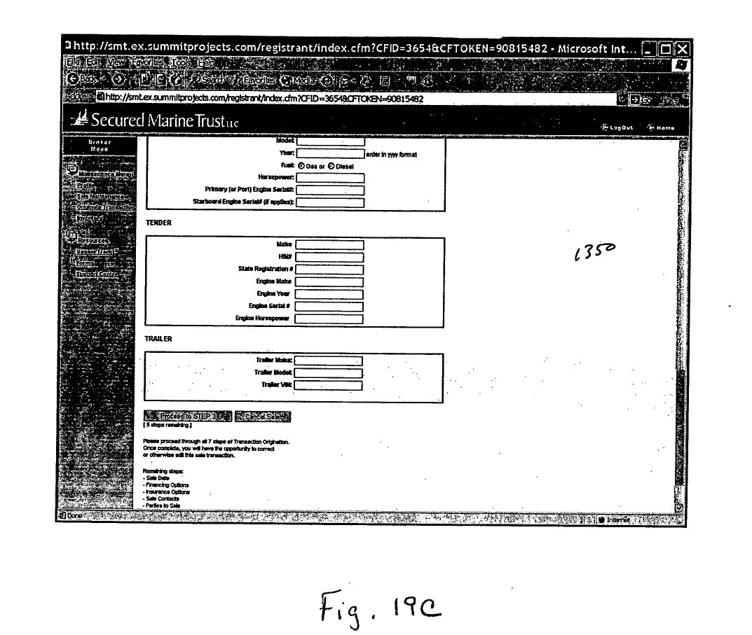

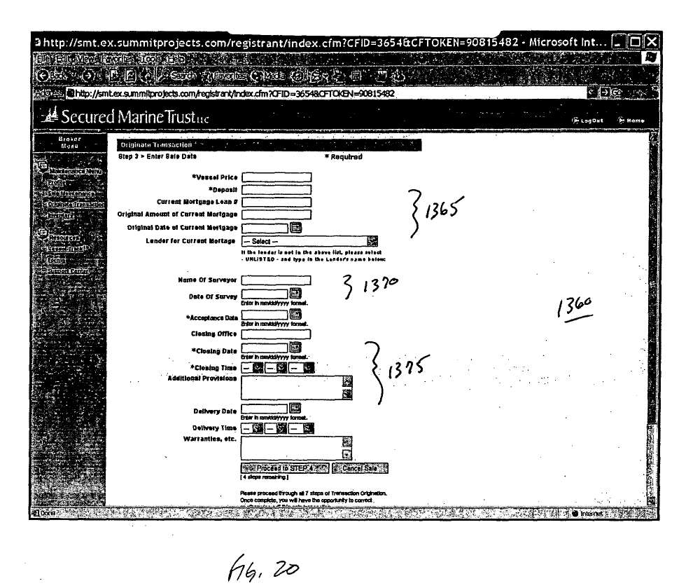

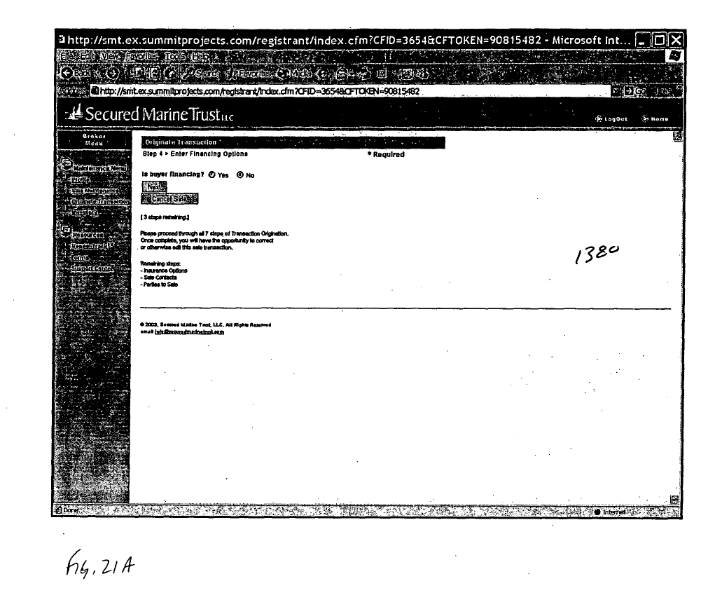

In one embodiment, illustrated in FIG. 2, the data tier 250 includes a plurality of Microsoft SQL 2000 databases, for example, two databases 252 and 254, which contain data relating to the SMT™ system 10 in particular (e.g., database 252) and relating to third party systems (e.g., database 254) such as, for example, on-line credit bureaus, financial institutions, or the like. FIGS. 17A-17D depict exemplary data records stored within the SMT™ system 10 data bases 252 and 254.

These modules and components are described more fully below.

### Functional Overview:

Generally speaking, clients of the SMT™ system 10 include:
a) Broker/Dealer: A broker/dealer utilizes the SMT™ system 10 to initiate purchase and sale transactions and maintain vessel inventories and listings. On behalf of a buyer and/or a seller, a broker/dealer utilizes the SMT™ system 10 as: 1. Escrow Agent; and/or 2. Documentation Agent. Dealer/Broker uses the SMT™ system 10 to download documents for the buyer's signature as required for a given transaction. The Dealer/Broker can log into the SMT™ system 10 to track the progress of sale transactions.
b) Buyers/Sellers: If buyers/sellers elect to use the SMT™ system 10, for example, as their Documentation Agent, they can log into the SMT™ system 10, obtain a Documentation Checklist and complete the specified data online. The buyers/sellers can log into the SMT™ system 10 to track progress of sale transactions. In one embodiment, buyers/sellers may access and complete applications for related services such as, for example, credit applications which can be used for obtaining retail marine finance or mortgages from financial institutions and marine insurance applications from underwriters, insurance agents, brokers and the like. In one embodiment, where the SMT™ system 10 includes a more consumer oriented interface, the buyers/sellers may directly secure such services.
c) Manufacturer/Builder: A manufacturer/builder uses the SMT™ system 10's on-line data entry screens to maintain and track inventory of new vessels, vehicles, real estate and the like. The manufacturer/builder logs into the SMT™ system 10 to track progress of sale transactions. In one embodiment, the SMT™ system 10 notifies the manufacturer/builder (e.g., via email) as pertinent milestones are reached in a transaction's timeline.
d) Wholesale Finance/Floor Plan Provider: Similarly, a wholesale finance/floor plan provider logs into the SMT™ system 10 to track progress of transactions and track the aging of their collateral. The SMT™ system 10 notifies the floor plan company (e.g., via email) as pertinent milestones are reached in the transaction's timeline.
e) Financial Lending Institution (e.g., Retail Banks): The SMT™ system 10 provides the necessary agreements for completing the transaction including, for example, marine security agreements and a first preferred ship's mortgage. Additionally, in one embodiment, the SMT™ system 10 utilizes the financial lending institutions loan documents in order to facilitate and perfect a secured marine loan transaction. Users at the financial lending institutions can log into the SMT™ system 10 to maintain and track loan progress and view and print documents.
f) Marine Surveyors: Marine Surveyors can register in a Marine Surveyor Directory included within the SMT™ system 10. Dealer/Brokers can print list of surveyors in a given state, county, or the like and process a survey order on behalf of the buyer.
g) Administrators: System administrators use the SMT™ system 10 to manage the entire transaction. On-line data entry screens (as illustrated herein and described below) are used to complete information for the disposition of a transaction. The SMT™ system 10 facilitates the generation of documents for which the administrator oversees (in accordance with its defined role) to complete the transaction.

In one embodiment, the SMT™ system 10 provides, monitors and updates timeline data (e.g., activity milestones, due dates, comments) pertaining to each transaction as a means for assisting all parties to the transaction in their respective roles. In one embodiment, the timeline functionality is incorporated within the aforementioned COUNTDOWN TO CLOSING^{SM} feature which provides a graphical illustration of activities and documents, and the status thereof, relevant to a given transaction.

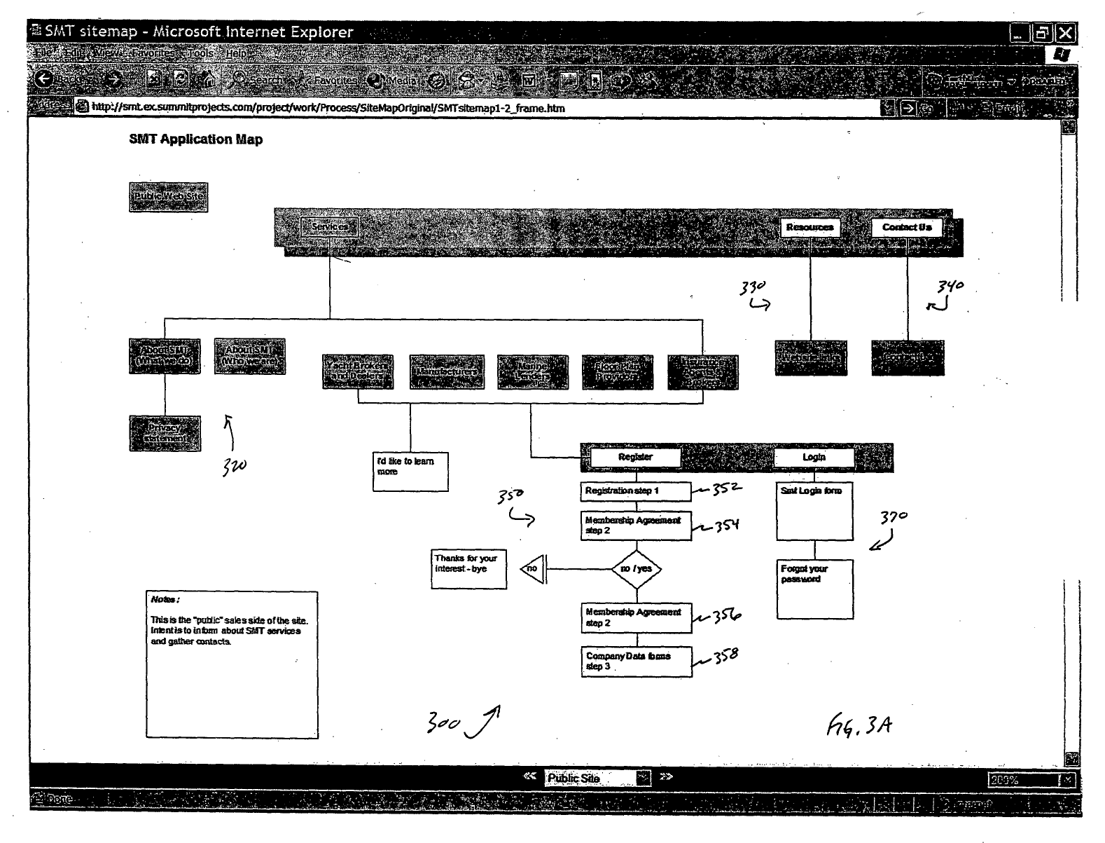

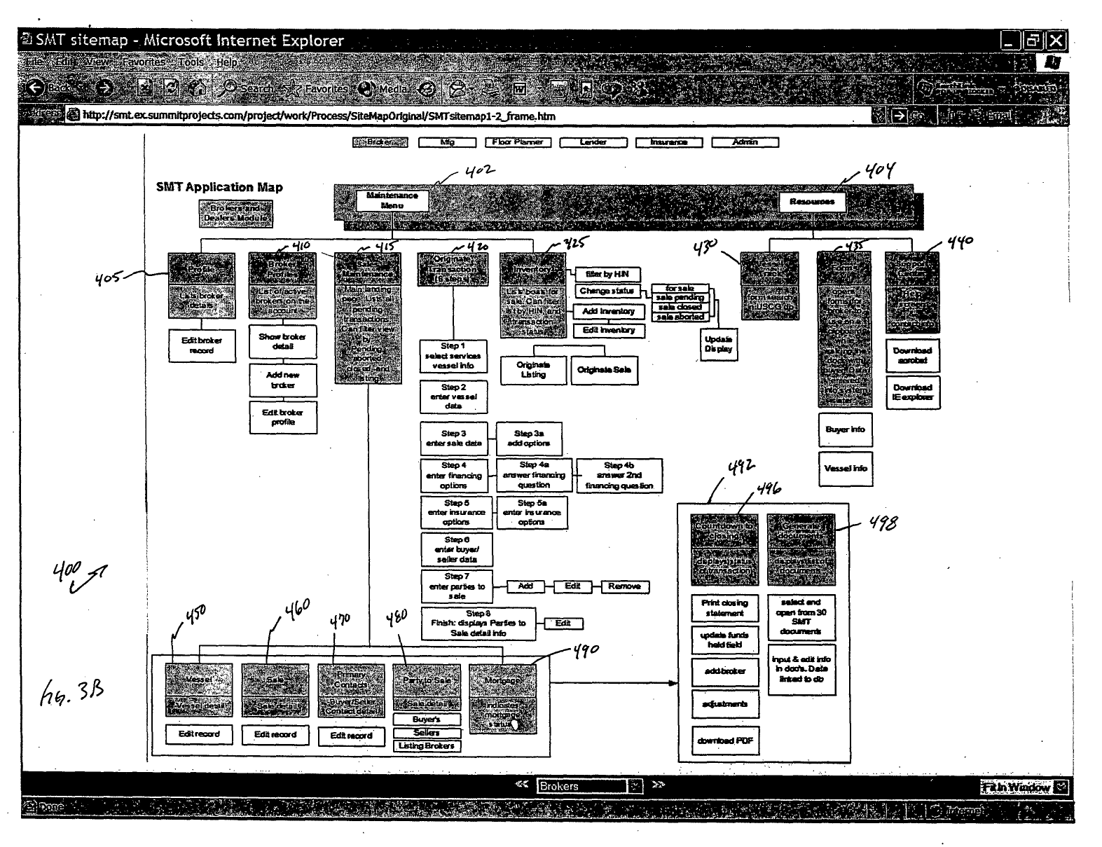

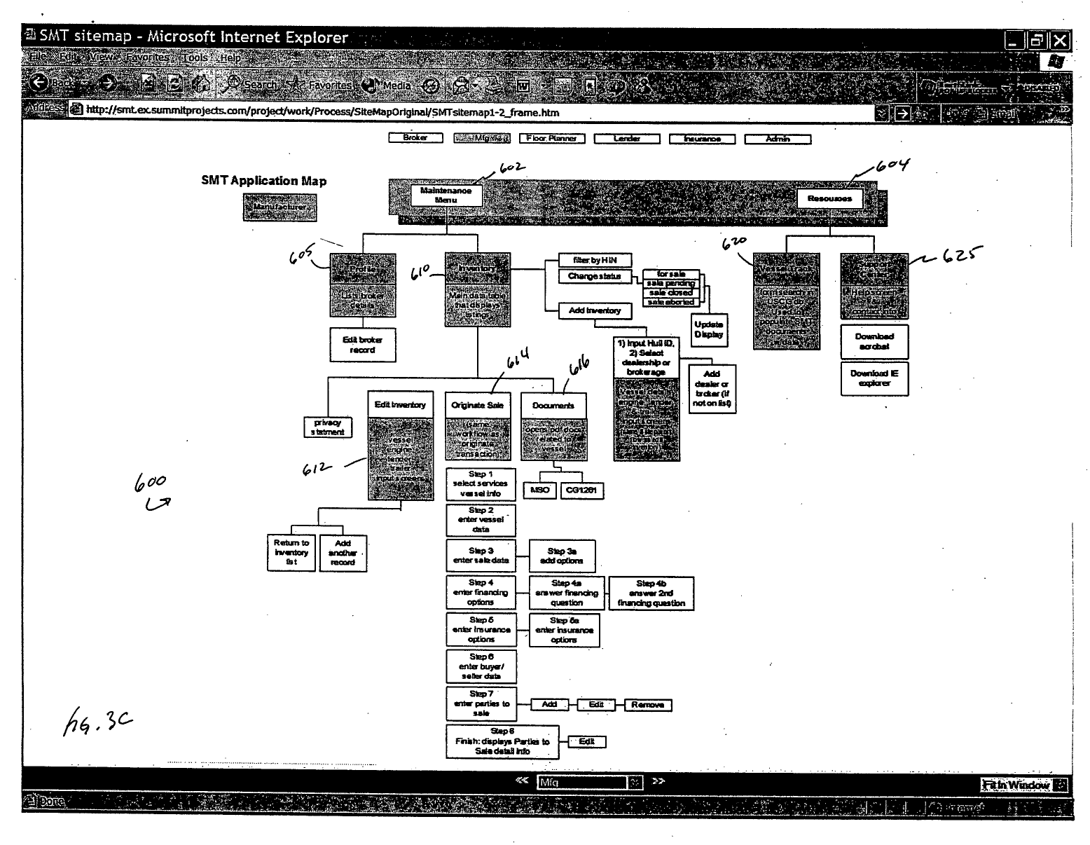

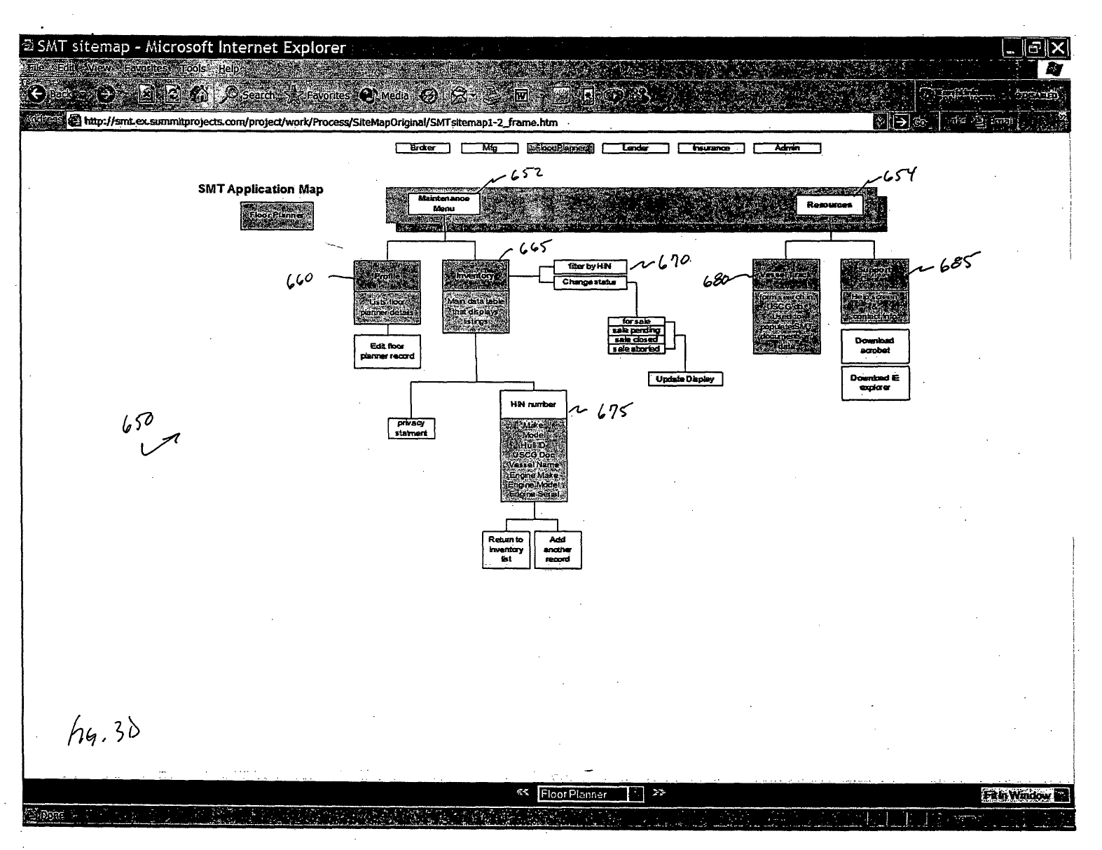

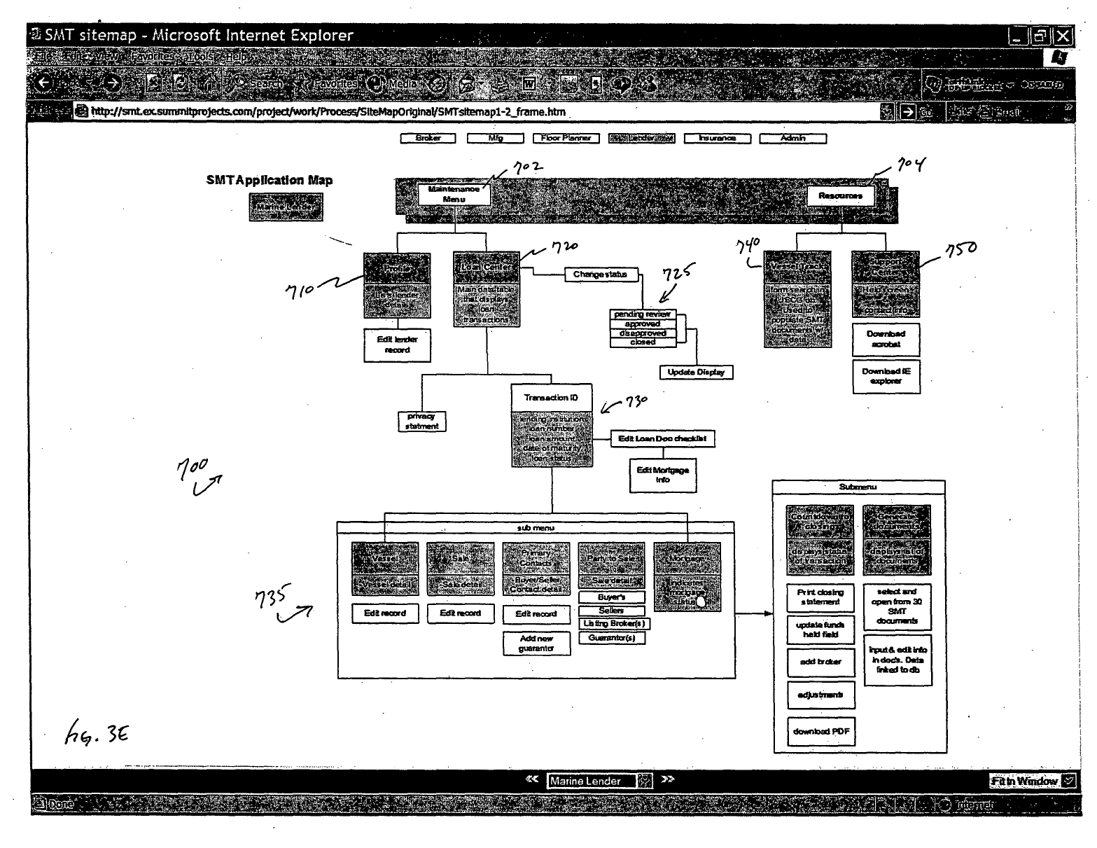

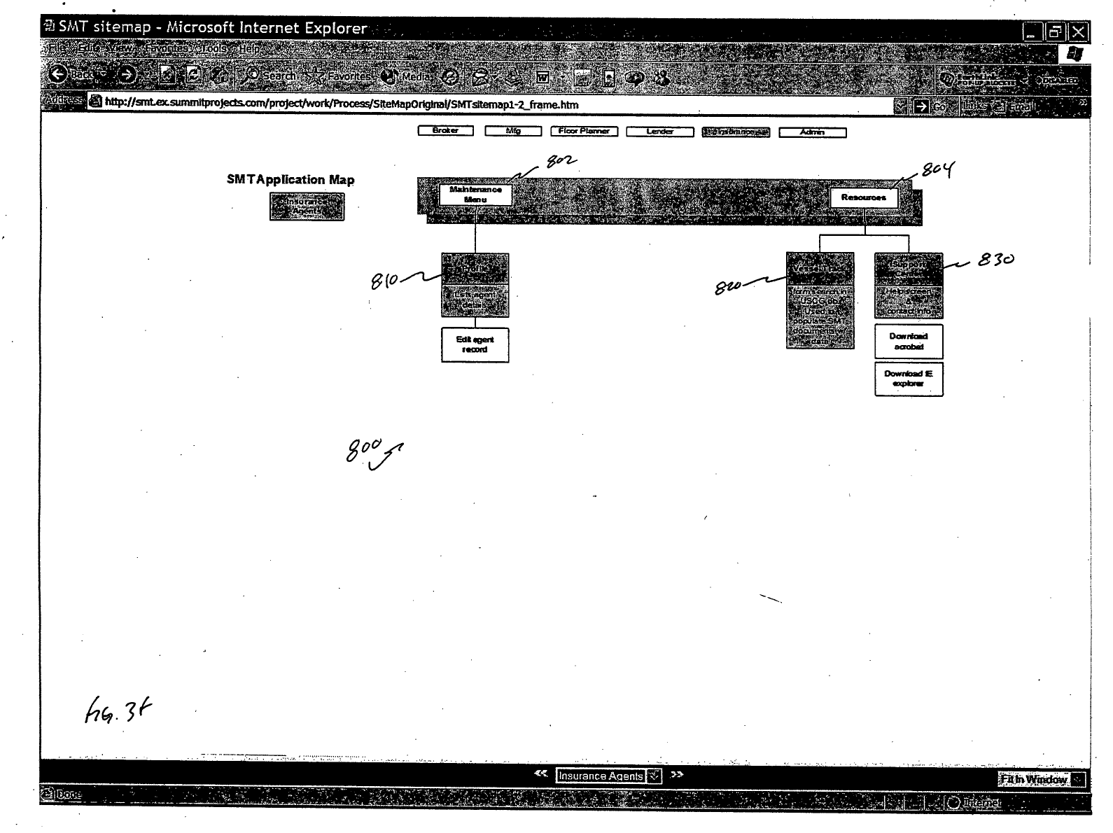

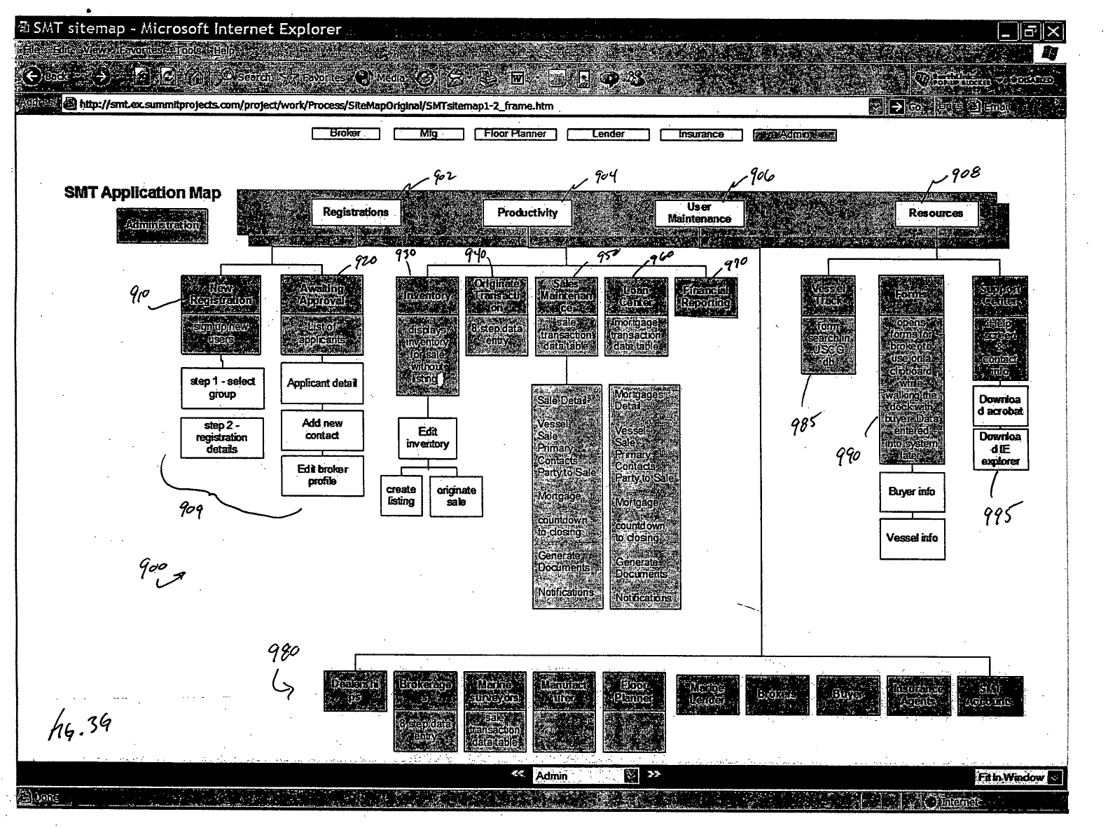

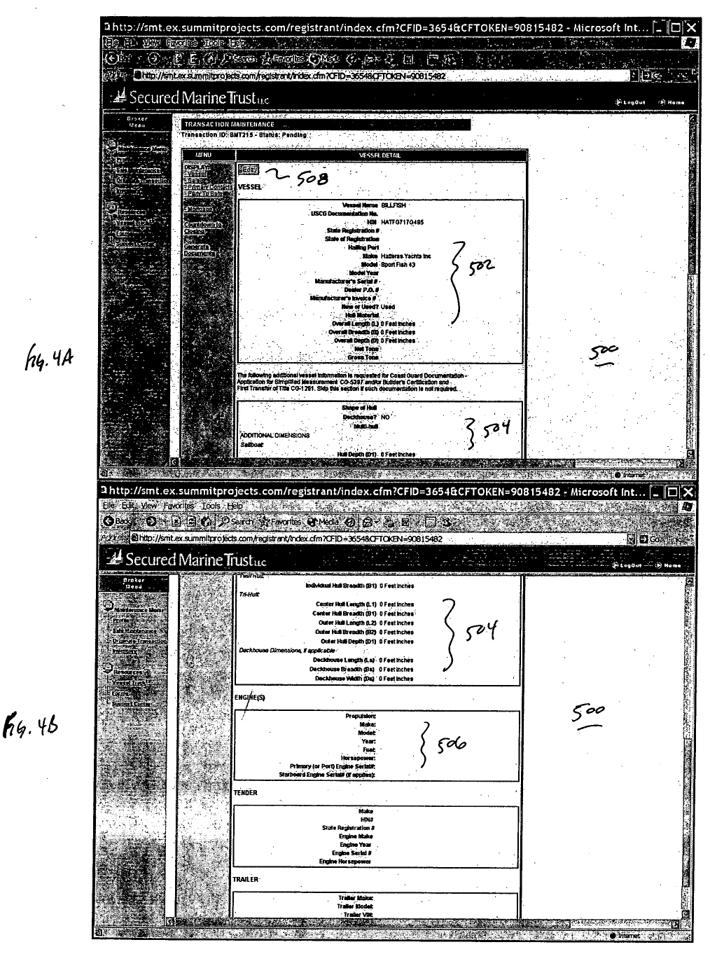

FIGS. 3A-3G illustrate application maps of one embodiment of a World Wide Web (WWW) based implementation of the SMT™ system 10 accessed using a standard web browser such as, for example, Microsoft's Internet Explorer. The WWW-based implementation provides an interactive view of transactions of interest to clients utilizing the SMT™ system 10. It should be appreciated that the application maps (e.g., FIGS. 3A-3G) and various presentation tier 210 HTML documents (e.g., FIGS. 4A-4B, 5A-5C, 6, 7A-7B, etc.) illustrates one embodiment of the SMT™ system 10. Accordingly, it is within the scope of the present invention to implementation other mapping schemes and HTML documents to provide functionality to clients of the SMT™ system 10.

FIG. 3A is an application map of a home page 300 of the SMT™ system 10. The home page 300 is made generally available to all persons accessing the SMT™ system 10 with a web browser. For example, it is a public document that is displayed to all persons without undergoing a security screening (e.g., no need to enter a registered user id and password). As illustrated in FIG. 3A the home page 300 includes general information about the SMT™ system 10 shown at 320, related resources shown at 330, and contact information shown at 340. Additionally, the home page 300 provides an access point for clients 20 of the SMT™ system 10. For example, new clients 20 may gain access to the SMT™ system 10 by first completing a registration process (as described below) shown at 350 and existing clients 20 (e.g., previously registered clients) may access the SMT™ system 10 at 370.

### Registration

As noted above, registration is a precursor to utilization of the SMT™ system 10.

Once registered, a client logs in and accesses program features, which are discussed below. Registration may be performed on-line, using the SMT™ system 10, or by completing a registration form (e.g., a paper application form) that is provided to a requester by an administrator of the SMT™ system 10. In an exemplary on-line registration process, a registrant:
1. Completes on-line registration questionnaire provided, for example, at 352 (FIG. 3A). In one embodiment, different questionnaires are provided that are customized to elicit information particular to a class of client (e.g. whether the client is a broker/dealer, manufacturer, financial institution, etc.). Table 1 illustrates typical information requested of a registrant. In one embodiment, the registrant information is parsed into data fields and stored in a data record such as, for example, record 62 illustrated in FIGS. 1 and 17A.
2. Once the registrant completes the questionnaire, the SMT™ system 10 sends (at 354) a confirmation email thanking them for their registration. In one embodiment, the SMT™ system 10 presents the registrant with a membership agreement that includes, for example, terms and conditions for using the SMT™ system 10.
3. If the registrant accepts the terms and conditions, the SMT™ system 10 sends (at 356) an alert that approval for use is typically granted upon review and acceptance of required registration fees. In one embodiment, the alert (e.g., sent in an email message) may also contain: marketing and support information, and link to the SMT™ system 10 web site.
4. Once registrant sends registration fee (e.g., electronically or by postal mail), the SMT™ system 10 acknowledges receipt of the fee and approves the registrant. At 358, the registrant's profile record (e.g., data within fields 62) is activated and available to other users within the SMT™ system 10. As described below, client's of the SMT™ system 10 may selectively review and update their profiles.

TABLE 1
General Information requested of the registrant:

| Field | Comment | Required |
|---|---|---|
| First Name | | Yes |
| Last Name | | Yes |
| Company Name | | Yes |
| Tax ID | | Yes |
| Department | | |
| Address1 | | Yes |
| Address2 | | |
| City | | Yes |
| State | | Yes |
| Postal Code | | Yes |
| Country | | Yes |
| Day Phone | | Yes |
| Mobile Phone | | |
| Fax | | Yes |
| Email Address | | Yes |
| Web Site Address | | |
| (URL) | | |
| User Name | For login. | Yes |
| Password | For login. Must be eight | Yes |
| | characters in length. | |

In some cases, additional information is requested from a registrant. Table 2 illustrates typical broker information. If Dealer/Broker completing the general information form also acts as a broker, they should include themselves in the broker list so that they are represented in this capacity.

TABLE 2
Individual Broker Information

| Field | Comment | Required |
|---|---|---|
| First Name | | Yes |
| Last Name | | Yes |
| Day Phone | | Yes |
| Mobile Phone | | |
| Fax | | Yes |
| Email | | |
| User Name | For login. | Yes |
| Password | For login. Must be eight characters in | Yes |
| | length. | |

In one embodiment, a dealer/broker (e.g., dealership or brokerage) can add, edit or delete individual brokers working or otherwise representing the dealership or brokerage's interest in a transaction. Individual brokers do not have edit permissions. In one embodiment, buyers/sellers do not individually register in the SMT™ system 10. Their ability to access the SMT™ system 10 is granted when a dealer/broker's identifies a buyer during setup of a sale transaction. Alternatively, the SMT™ system 10 includes a consumer oriented interface wherein buyers/sellers may register as clients of the system 10. A Marine Surveyor is also required to enter additional information, namely the state, county or territory of operation.

In one embodiment, registrants have one of five status levels: “pending”, “approved”, “declined”, “inactive”, or “guest”. A default status is pending. The guest status allows for the inclusion of users that are potential registrants. For example, this is done with non-registered financial institution such as a retail banks to support collection of data pertaining to outstanding loans.

Once registered, a user may login (at 370 of FIG. 3A) and invoke the functionality of the SMT™ system 10.

FIG. 3B is an application map of a Broker/Dealer Module interface 400. As illustrated in FIG. 3B, menu options include maintenance 402 and resources 404 features, providing access to:
1. A broker/dealer's profile 405, including display and edit functionality;
2. Individual broker profiles 410, including display, edit, add, and delete functionality;
3. Sales Maintenance 415, including display and edit functionality of vessel, sale, contact and mortgage information for transactions by, for example, a status of the transaction. Status include, for example, pending, closed, aborted, listing;
4. Originate Transaction 420, including a multi-step process by which a broker/dealer initiates and defines a transaction by selecting required services, object information (by hull identification number (HIN), sales, financing, and insurance information as well as the parties to the transaction;
5. Inventory 425, including display, edit, add, and delete functionality;
6. VESSEL TRACK^{SM} 430 functionality for a lookup of pertinent vessel information in third party systems such as, for example, the U.S. Coast Guard's databases of registered vessels;
7. Forms library 435, including display and output (e.g., printing) of forms; and
8. Support Center 440, including context sensitive help screens and contact information functionality.

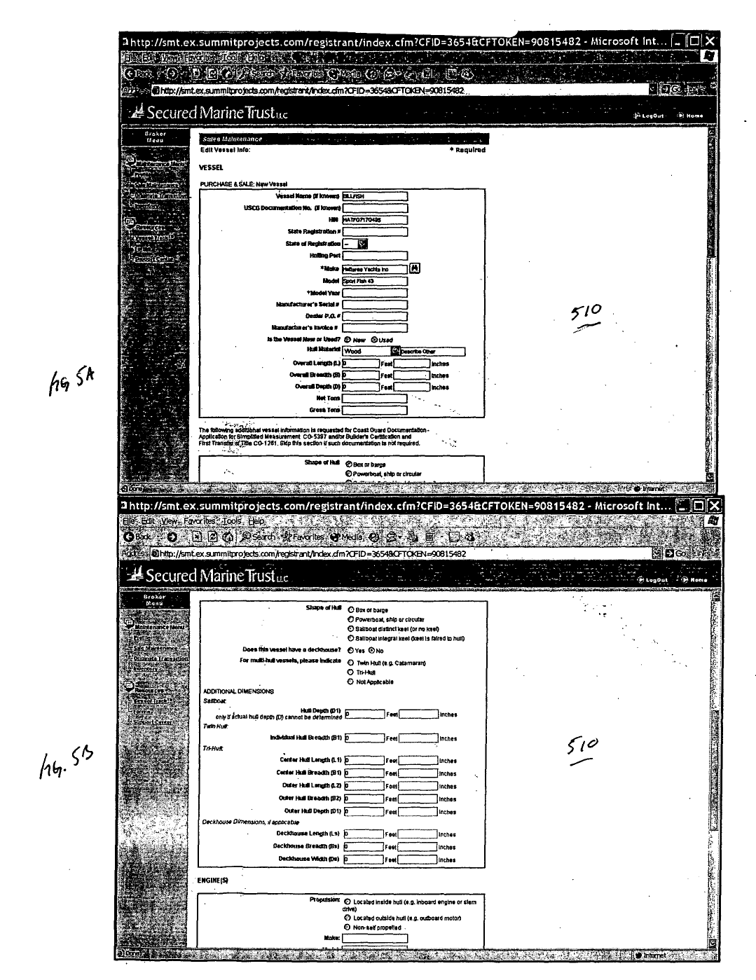

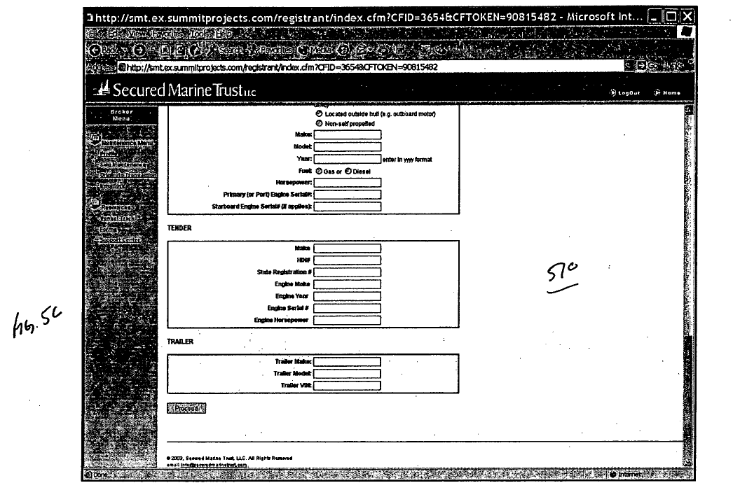

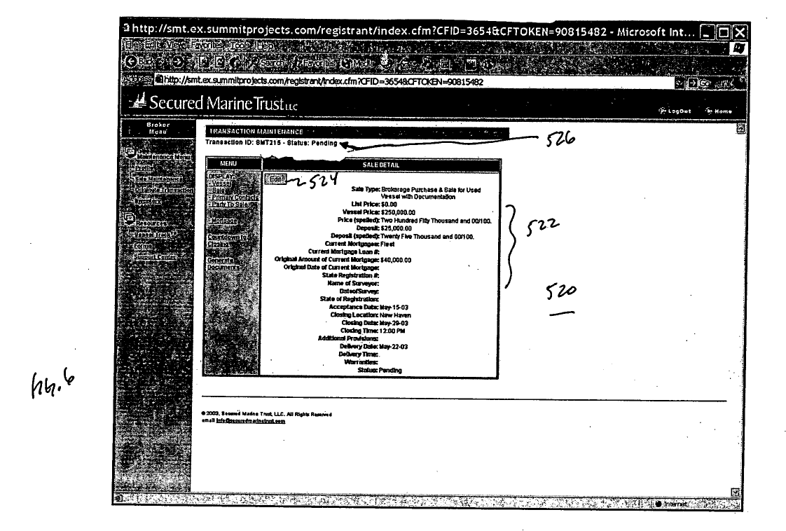

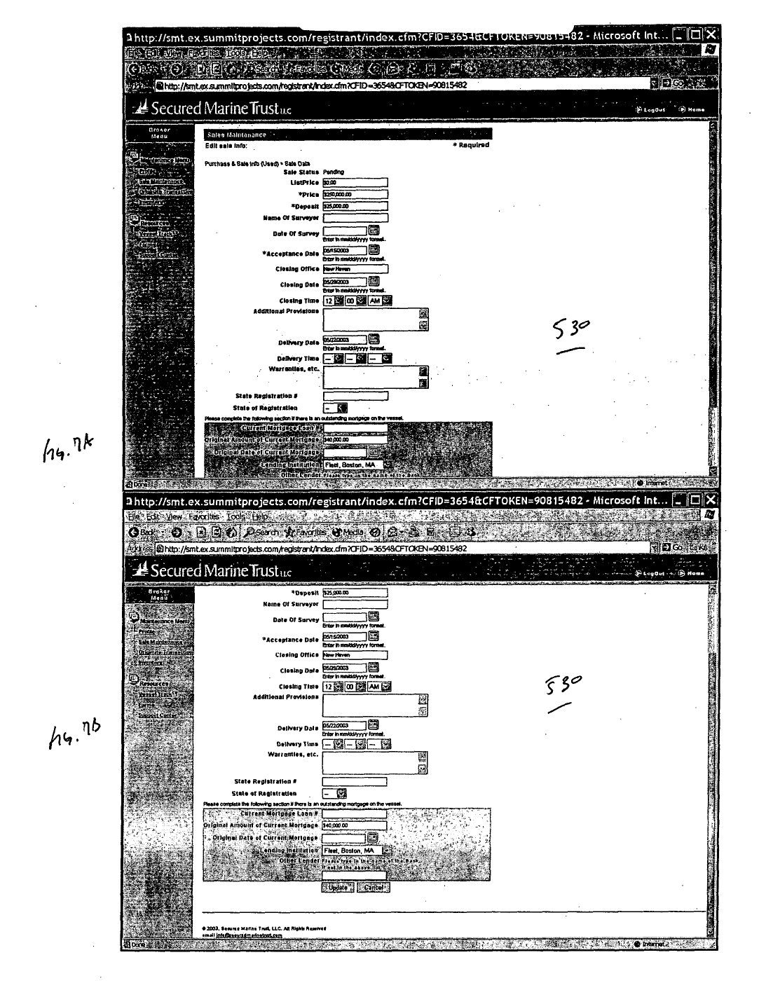

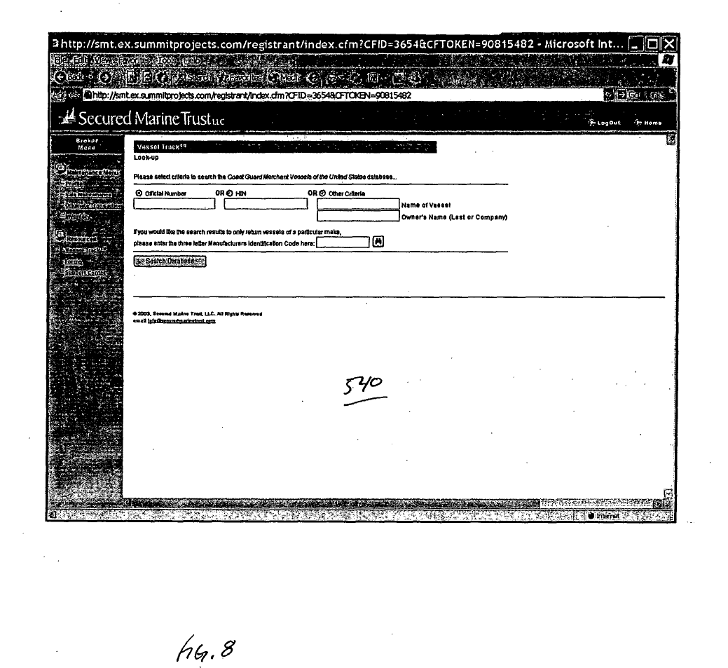

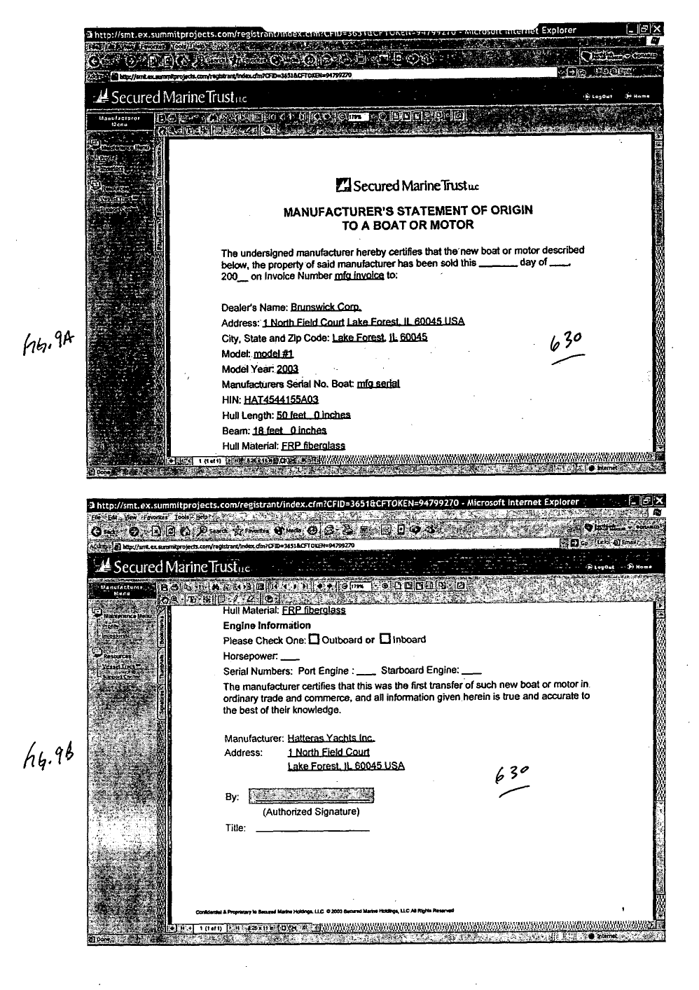

FIGS. 4A and 4B depict one embodiment of a user interface 500 providing Vessel Detail information accessible at 450 from the Sales Maintenance 415 functionality of the Broker/Dealer Module interface 400 (FIG. 3B). As shown in FIGS. 4A and 4B, a number of data fields providing, for example, registration information 502, vessel dimensions 504, engine information 506, that is of interest to clients regarding vessels involved in one or more transactions within the SMT™ system 10. As noted above, the information 502, 504, and 506 is updated by invoking an edit command 508 which loads an interface 510 illustrated in FIGS. 5A-5C for updating the information 502, 504, and 506. Similarly, sales data is accessible at 460 from the Sales Maintenance 415 functionality of the Broker/Dealer Module Interface 400 (FIG. 3B). The sales data is displayed, for example, in a user interface 520 (FIG. 6) having information 522 that can be updated by invoking an edit command 524 to load an interface 530 depicted in FIGS. 7A and 7B. Once a transaction involving the object is created a transaction id 526 (FIG. 6) is assigned.

Although not illustrated in detail, it should be appreciated that interfaces display and provide editing of data fields relating to Primary Contacts 470, Party to Sale 480 and Mortgage 490 data are accessible for display and editing through the Sales Maintenance 415 functionality through one or more user interfaces, as are generally known in the art to be configured and operating in a similar manner as the aforementioned sales data interfaces 520 (FIG. 6) and 530 (FIGS. 7A and 7B).

It should be appreciated that the Broker/Dealer Interface Module 400 builds data records for storing the data fields in the data store 60. For example, FIGS. 17A-17D illustrate data records 62-74 holding information corresponding to the registrant information 62, inventory 64, vessel data 66, parties to transaction (e.g., Party to Sale) 68, financing 70, transaction (e.g., Sales Transaction) 72 and closing 74 information. In accordance with the present invention, the data records corresponding to a particular transaction (e.g., the specific registrant 62, inventory 64, vessel 66, parties 68, financing 70, transaction 72 and closing 74 information involved in a transaction) are linked by means of the transaction id 536 (FIG. 6) assigned at a time of creation of the transaction record 72. Referring again briefly to FIG. 3B, as the transaction and/or components (e.g., documents and/or activities within milestones of the transaction) are modified the revised transaction record is made available to all users of the SMT™ system 10 in real-time. For example and as is illustrated in FIG. 3B at 492, the aforementioned COUNTDOWN TO CLOSING^{SM} feature 496 provides a mechanism for each constituent (e.g., the clients) of a particular transaction to review and/or update milestones to that transaction. In one embodiment, the SMT™ system 10 administrators are primarily the persons updating milestones of a transaction. However, the clients can display and review details of the transaction utilizing the COUNTDOWN TO CLOSING^{SM} feature. In another aspect of the present invention, a Generate Documents module 498 retrieves the current information from the data records corresponding to a transaction and provides (e.g., creates or generates) the documentation needed to process and complete the transaction. As with the COUNTDOWN TO CLOSING^{SM} feature, documents created with the Generate Documents module 498 reflect the most current information in the SMT™ system 10 at the time of viewing and/or creation. Additionally details of the COUNTDOWN TO CLOSING^{SM} feature 496 and the Generate Documents module 498 are provided below.

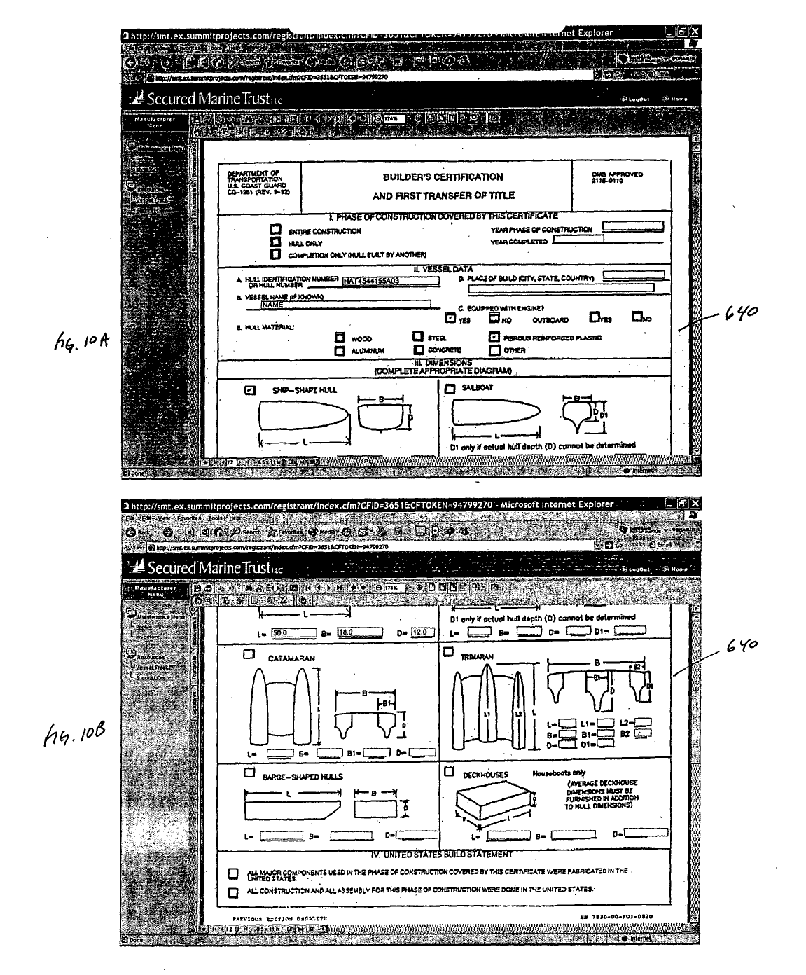

FIG. 8 depicts one embodiment of a user interface 540 providing a look-up function for locating information (e.g., registration information) regarding a vessel within a third party database such as, for example, the U.S. Coast Guard's merchant vessel data records. It should be appreciated that the present invention contemplates searching third party sources of information that may be of interest to clients of the SMT™ system 10.

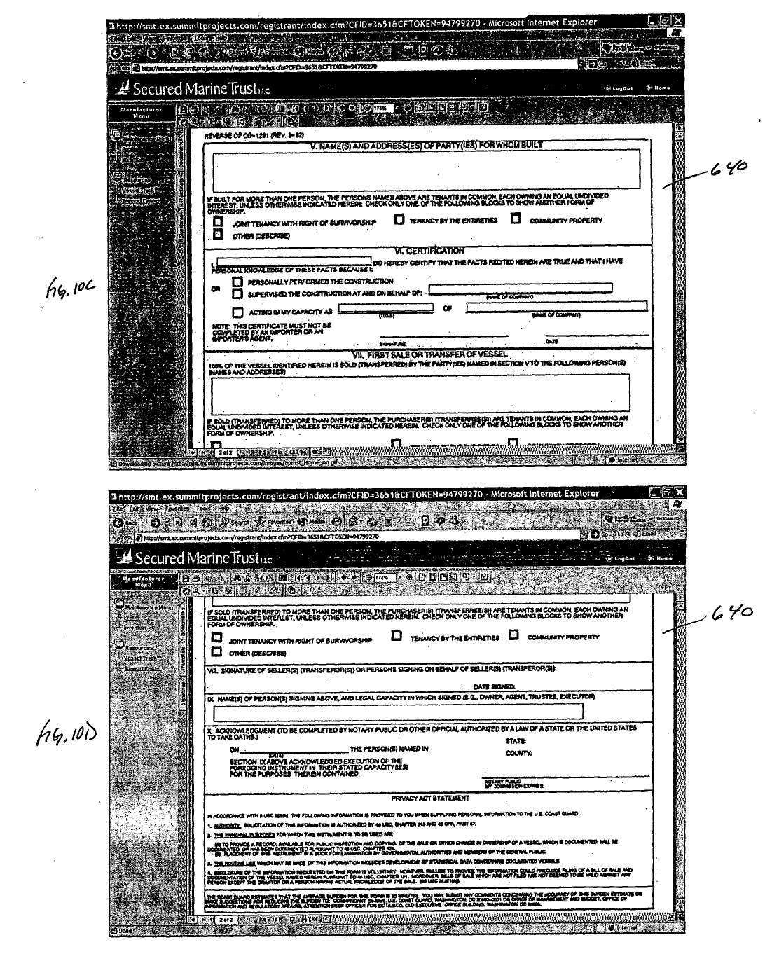

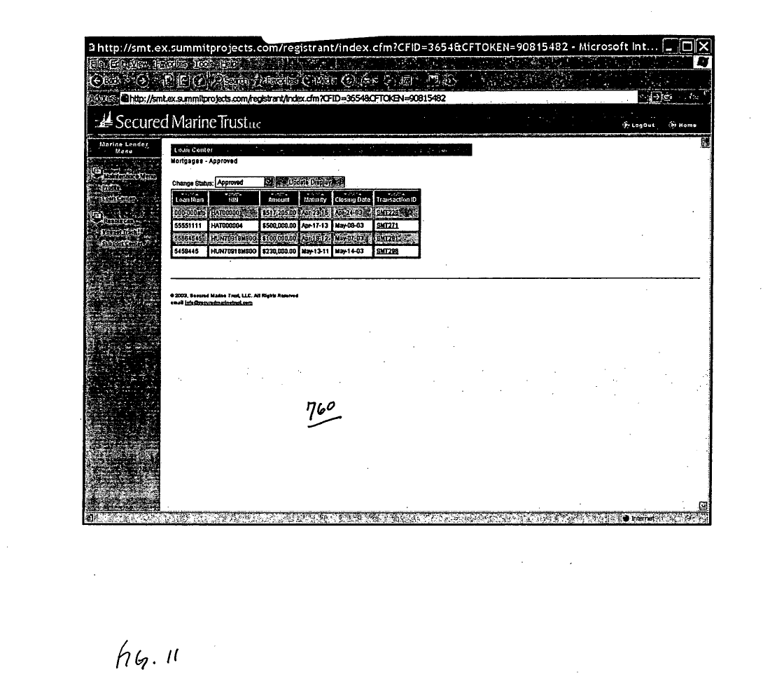

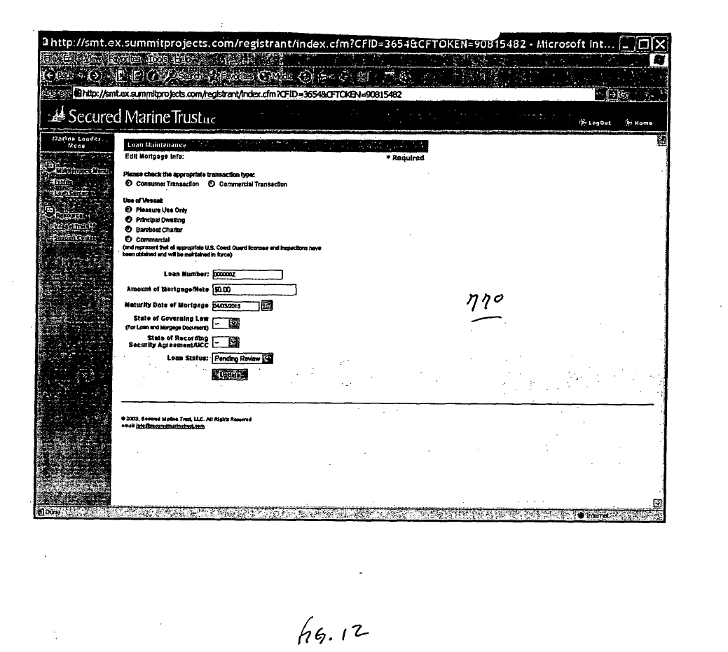

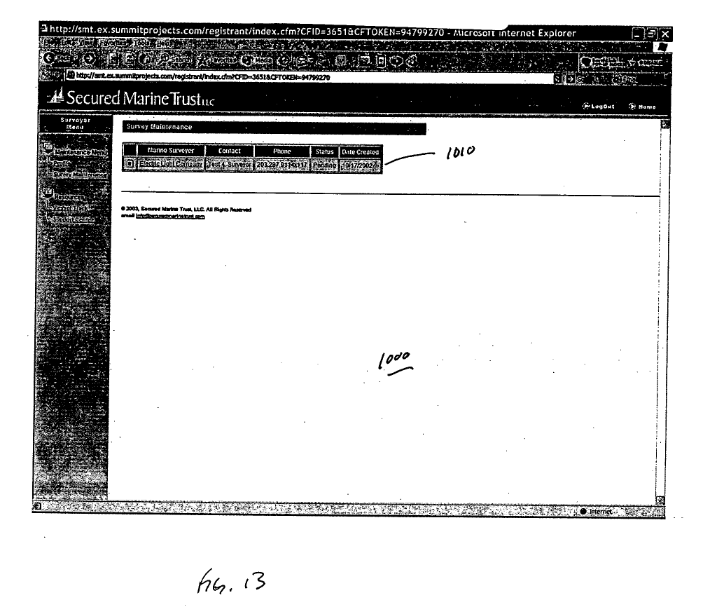

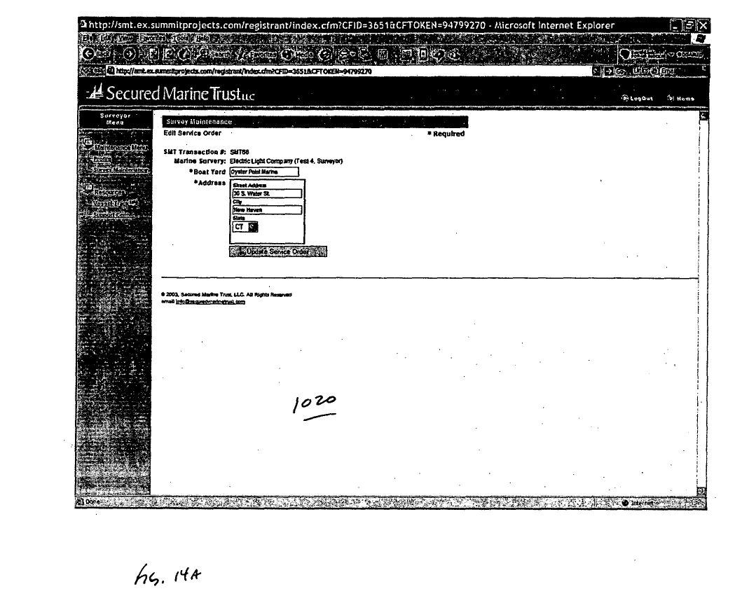

FIG. 3C is an application map of a Manufacturer Module interface 600. As illustrated in FIG. 3C, menu options include maintenance 602 and resources 604 features, providing access to:
1. A manufacturer's profile 605 (e.g., registrant information 62 for the manufacturer), including display and edit functionality;
2. Inventory Maintenance 610, including display, edit, add, and delete functionality 612 as well as Originate Transaction 614 and document production 616 functionality. In one embodiment, the Originate Transaction 614 functionality includes a multi-step process by which a manufacturer initiates and defines a transaction by selecting required services, inventory by HIN, sales, financing, and insurance information as well as the parties to the transaction. In one embodiment, the document production functionality 616 includes creation of electronic versions of a Manufacturer's Statement of Origin document 630 (depicted in FIGS. 9A and 9B) and a Builder's Certification and First Transfer of Title document 640 (depicted in FIGS. 10A-10D) as are generally known. It should be appreciated that changes (e.g., add, edits and delete actions) to inventory are reflected as updates to inventory records and fields illustrated at 64 (FIGS. 1 and 17B);
3. VESSEL TRACK^{SM} 620 functionality for a lookup of pertinent vessel information in third party systems (FIG. 8); and
4. Support Center 625, including context sensitive help screens and contact information functionality.

FIG. 3D is an application map of a Floor Planner Module interface 650. As illustrated in FIG. 3D, menu options include maintenance 652 and resources 654 features, providing access to:
1. A floor planner's profile 660 (e.g., registrant information 62 for the floor planner), including display and edit functionality;
2. Inventory Maintenance 665 (e.g., inventory information 64), including display 670 and add 675 functionality;
3. VESSEL TRACK^{SM} 680 functionality for a lookup of pertinent vessel information in third party systems; and
4. Support Center 685 including context sensitive help screens and contact information functionality.

FIG. 3E is an application map of a Lender Module interface 700. As illustrated in FIG. 3E, menu options include maintenance 702 and resources 704 features, providing access to:
1. A lender's profile 710 (e.g., registrant information 62 for a lender), including display and edit functionality;
2. Loan Center Maintenance 720, including display 725 (e.g., selective display by status) and edit 730 functionality;
3. VESSEL TRACK^{SM}0 740 functionality for a lookup of pertinent vessel information in third party systems; and
4. Support Center 750 including context sensitive help screens and contact information functionality.

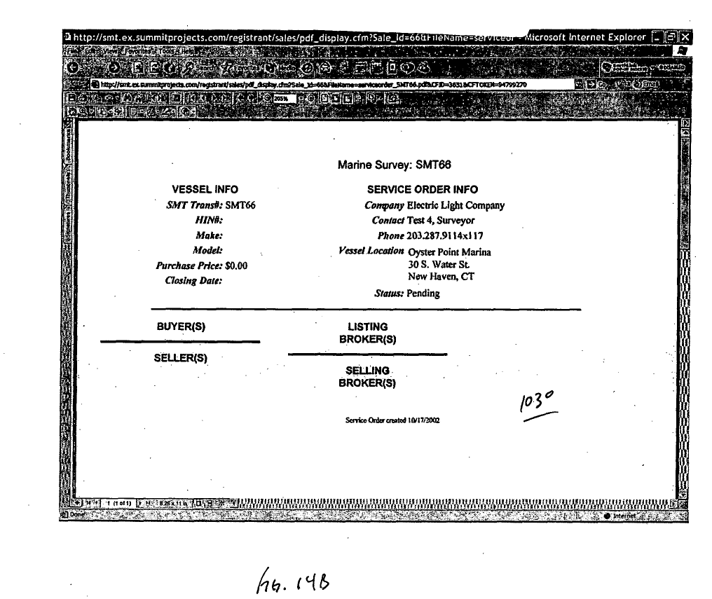

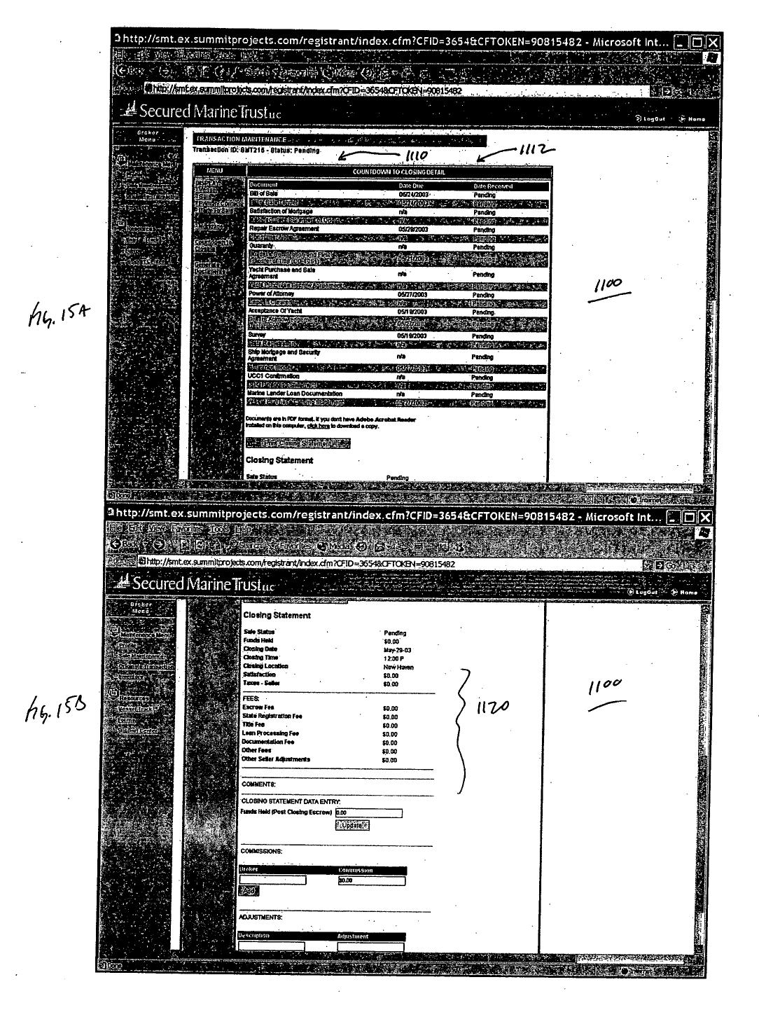

FIG. 11 depicts one embodiment of a user interface 760 for invoking the Loan Center Maintenance 720 functionality. Through the user interface 760 and Loan Center Maintenance functionality 720 information pertinent to the transaction can be reviewed and modified. For example, at 735, access is provided to the data fields pertaining to the Vessel Detail data 500 (FIGS. 4A and 4B), Sales data 530 (FIGS. 7A and 7B), Primary Contacts, Party to Sale and Mortgage data. FIG. 12 depicts one embodiment of a user interface 770 for displaying and selectively editing the mortgage data and for updating corresponding financial records 70.

FIG. 3F is an application map of an Insurance Agent Module interface 800. As illustrated in FIG. 3F, menu options include maintenance 802 and resources 804 features, providing access to:
1. An agent's profile 810 (registrant information 62 for the agent), including display and edit functionality;
2. VESSEL TRACK^{SM} 820 functionality for a lookup of pertinent vessel information in third party systems; and
3. Support Center 830 including context sensitive help screens and contact information functionality.

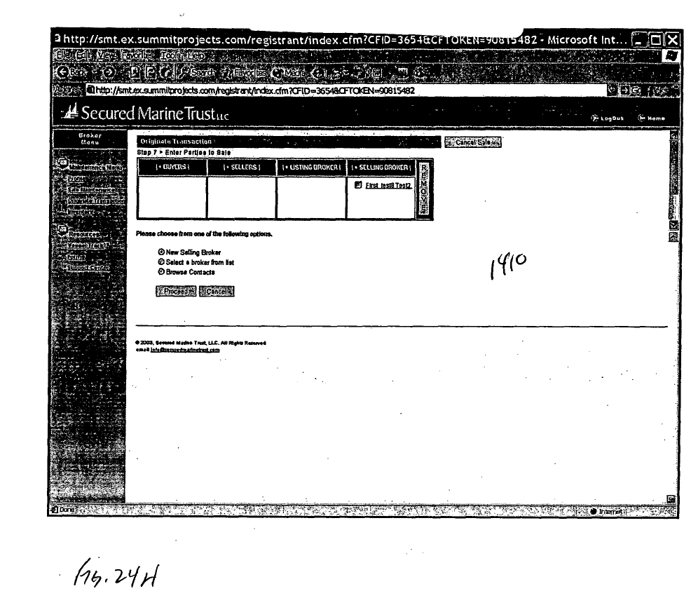

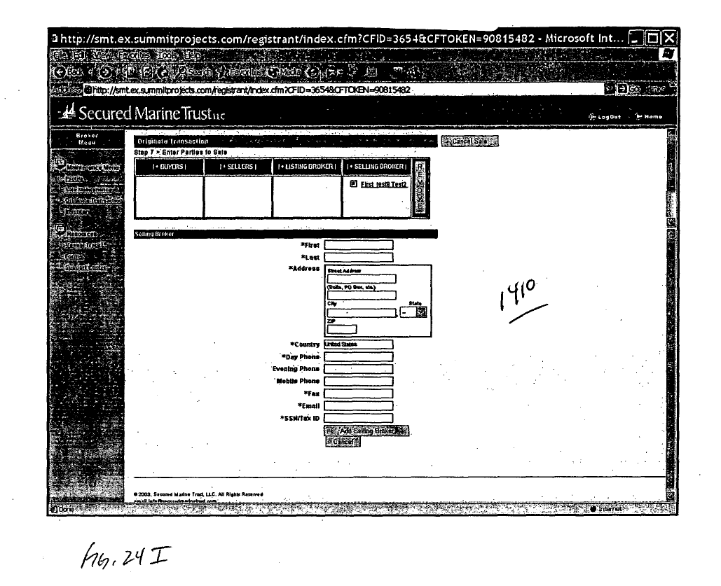

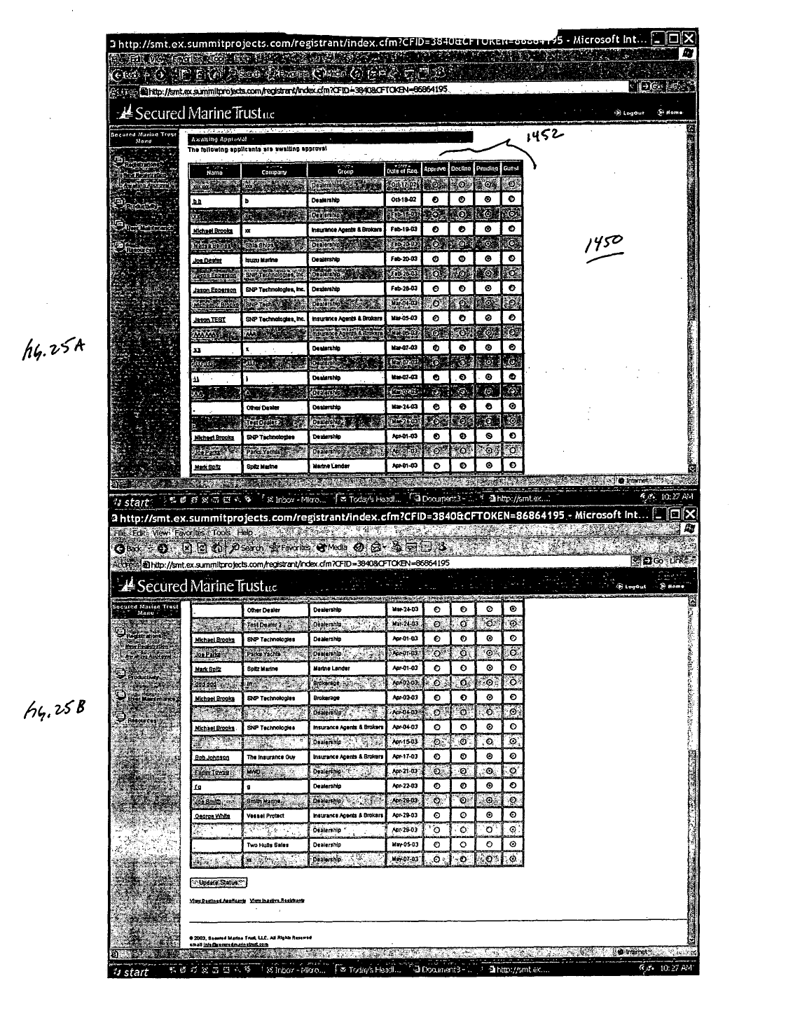

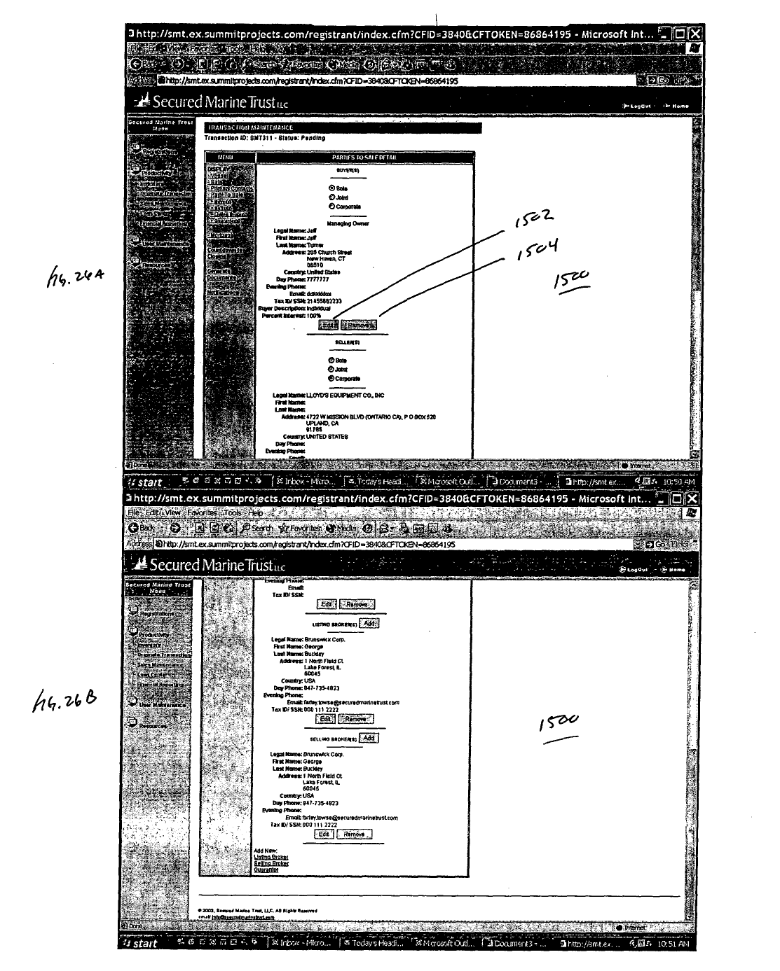

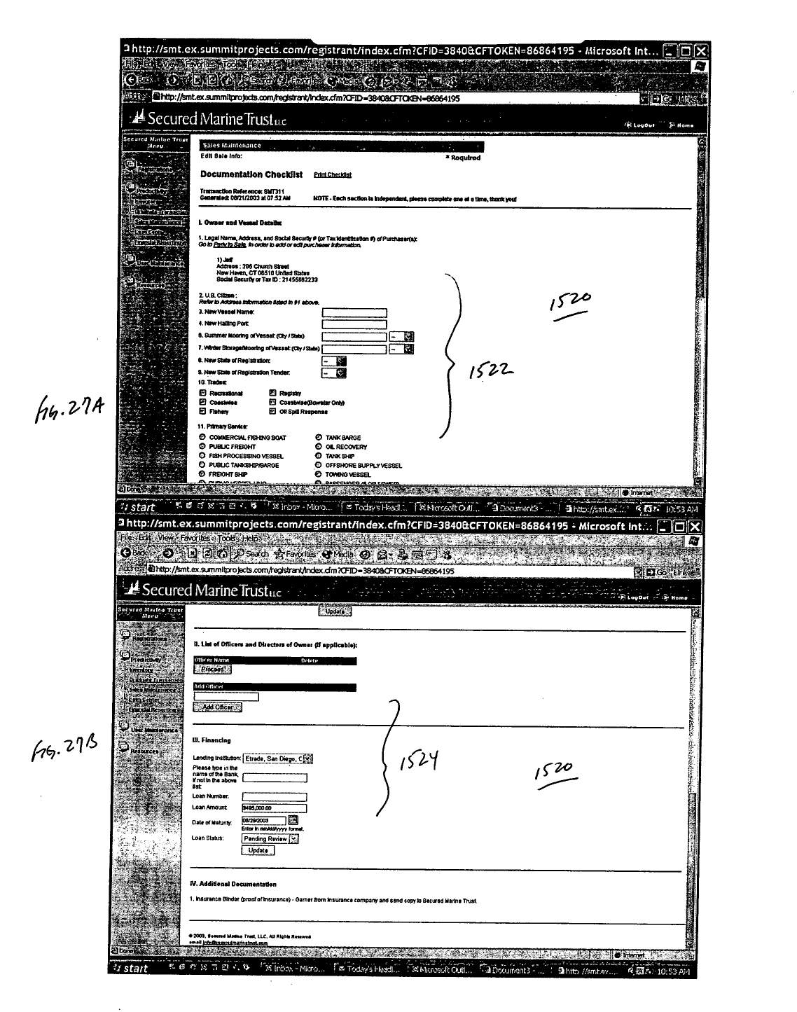

FIG. 3G is an application map of an Administration Module interface 900. As illustrated in FIG. 3G, menu options include registrations 902, productivity 904, user maintenance 906 and resources 908 features, providing access to:
1. User Maintenance 909 including New Registrations 910 and Applicants awaiting approval 920, provides display, add, edit and delete functionality to registrant information 62 for selective clients. In one embodiment, new registrant information is received in, for example, and is input into the SMT™ system 10 by an administrator. To assist in this effort, the New Registration 910 functionality prompts the administrator to enter key data from the form into predetermined fields of a user interface. In one embodiment, illustrated in FIGS. 25A and 25B, a user interface 1450 assists the administrator review and process registrations received on-line, for example, from registrants that invoked the registration process 350 (FIG. 3A). The user interface 1450 may include features 1452 to allow the administrator to efficiently review and update a status of registrants, as well as to edit details of the registrant information record 62 built at the conclusion of the on-line registration process;
2. The Productivity functions 904 provide display, edit, add, and delete functionality for respective Inventory information 64 at 930, Originate Transaction (which functionality is described in detail below) at 940, Sales information 72 at 950 and financial information 70 at Loan Center 960. Additionally, Financial Reporting functionality 970 provides a utility to, for example, forecast escrow balances. It should be appreciated that the Sales Maintenance 950 and Loan Center 960 functions for the SMT™ system 10 administers is more robust that those functions provided clients of the system 10. For example, as is illustrated in FIGS. 26A and 26C, a transaction maintenance interface 1500 includes features for editing 1502 and deleting 1504 capability of portions of the transaction record 72 whereas client interfaces such as interface 530 (FIG. 7A-7B) provides only edit features. Additionally, the administrator functions include a Documentation Checklist interface 1520 illustrated in FIGS. 27A and 27B. Using the Documentation Checklist interface 1520, an administrator reviews, validates and, as needed, edits buyer/seller and/or vessel data 1522 and related transactional information 1524;
3. User Interfaces, illustrated at 980;
4. VESSEL TRACK^{SM} 985 functionality for a lookup of pertinent vessel information in third party systems; and
5. Forms library 990, including display and output (e.g., printing) of forms; and
6. Support Center 995, including context sensitive help screens and contact information functionality.

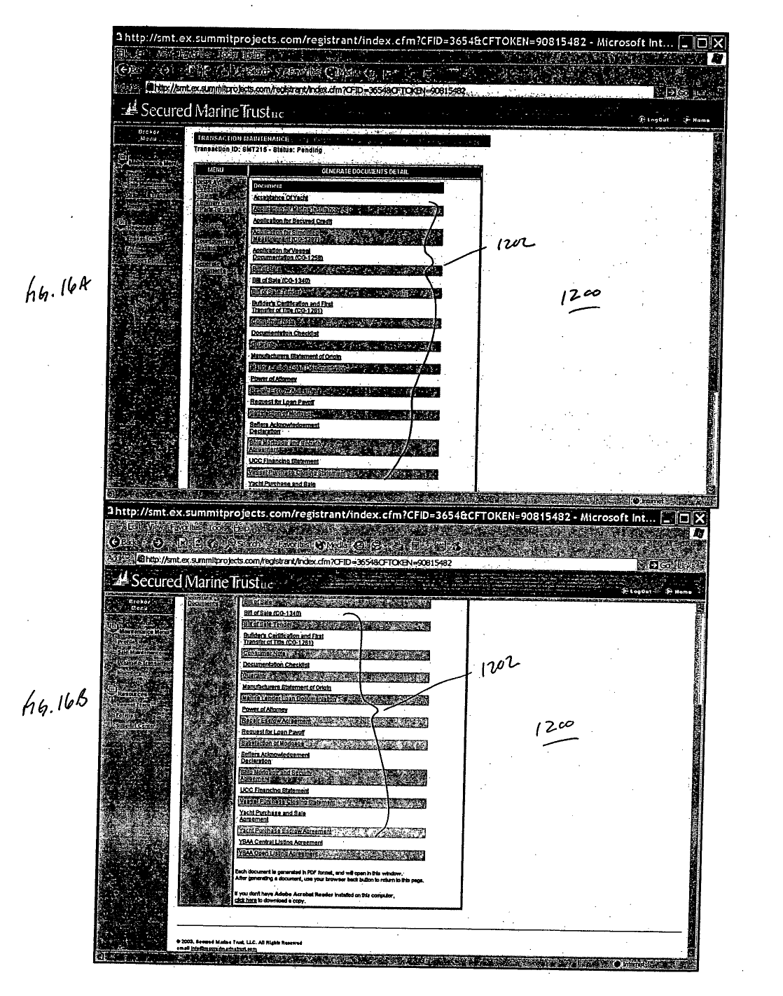

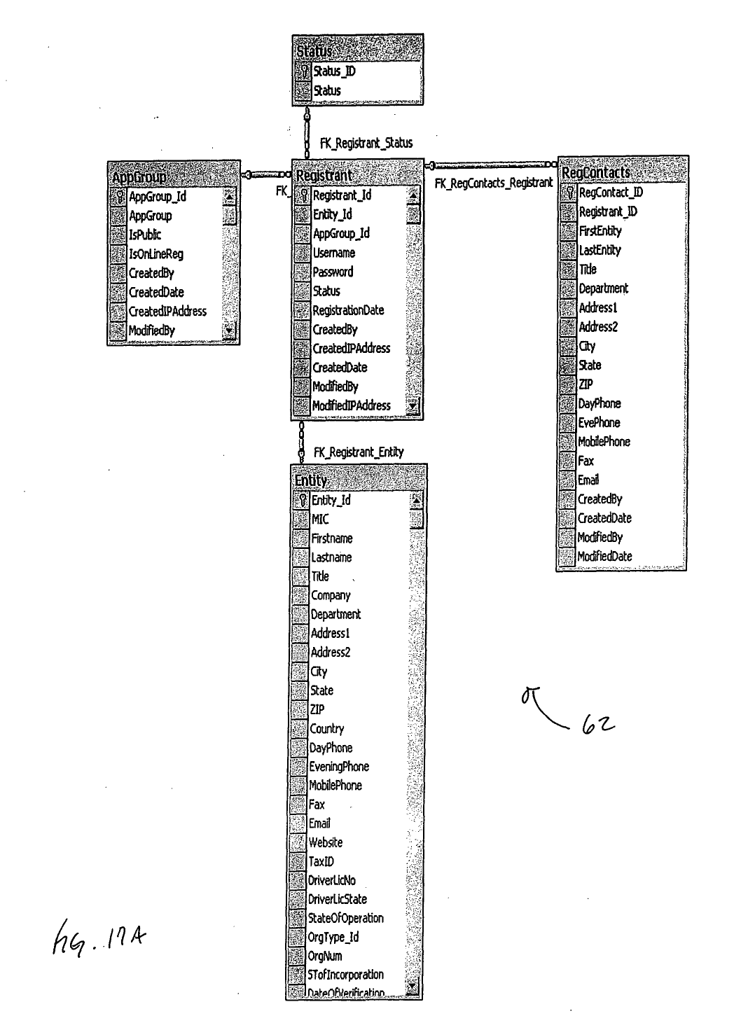

One transaction type within the SMT™ system 10 is a service order transaction which requests services from a marine surveyor. FIG. 13 depicts one embodiment of a screen interface 1000 illustrating a service order transaction 1010. Details of the service order transaction may be displayed and edited in an interface 1020 (FIG. 14A). Once complete, an electronic version 1030 of the service order 1020 may be generated (FIG. 14B).

Some exemplary features of the inventive SMT™ system 10 follow.

### COUNTDOWN TO CLOSING^{SM}.

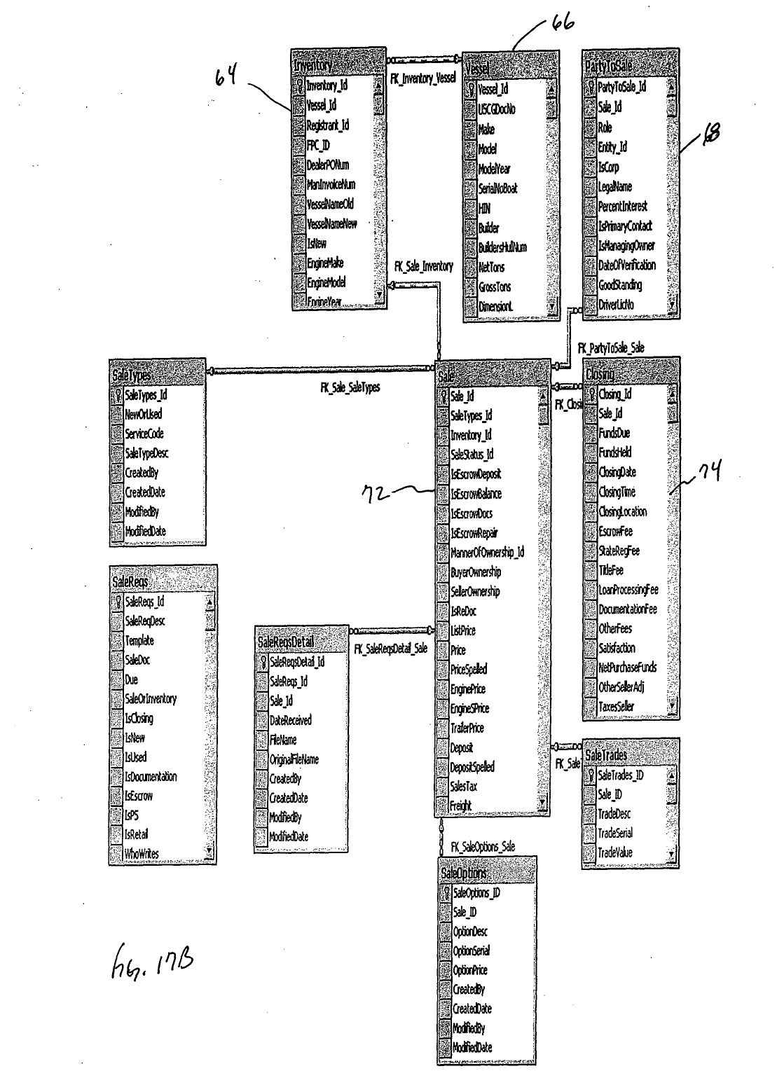

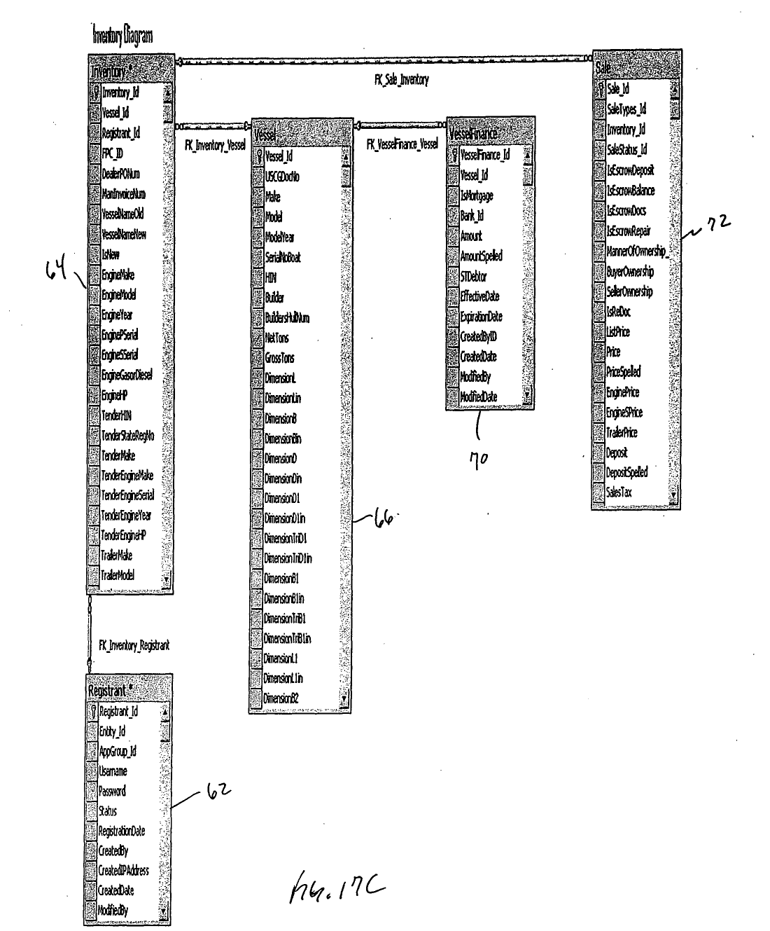

FIGS. 15A and 15B depict one embodiment of a user interface 1100 displaying the COUNTDOWN TO CLOSING^{SM} functionality. In accordance with the present invention, the COUNT DOWN TO CLOSING^{SM} functionality is a real-time, interactive transaction tracking mechanism wherein milestones 1110 needed to complete a transaction (e.g., required documents and activities) and a “snapshot” of their respective status 1112 (including estimated due date and date actually received) are graphically displayed. Constituents of a particular transaction can view transaction status and progress toward completion of pertinent deadlines (e.g., milestones). The SMT™ system 10 administrators/closing coordinators utilize the COUNTDOWN TO CLOSING^{SM} functionality to monitor transaction progress and to ensure necessary milestones are reached and that the transaction closes (e.g., is completed) within a predetermined time schedule. In one embodiment, the COUNT DOWN TO CLOSING^{SM} interface 1100 includes closing information 1120 (including an estimated closing date, location and a summary of disbursements).

### Generate Documents.

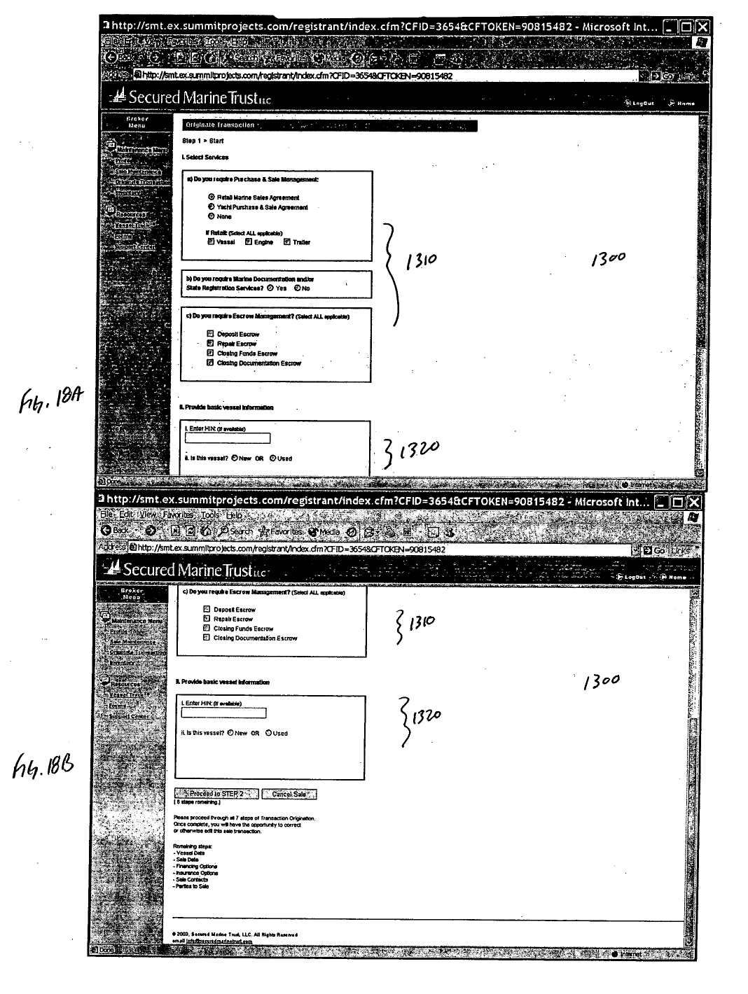

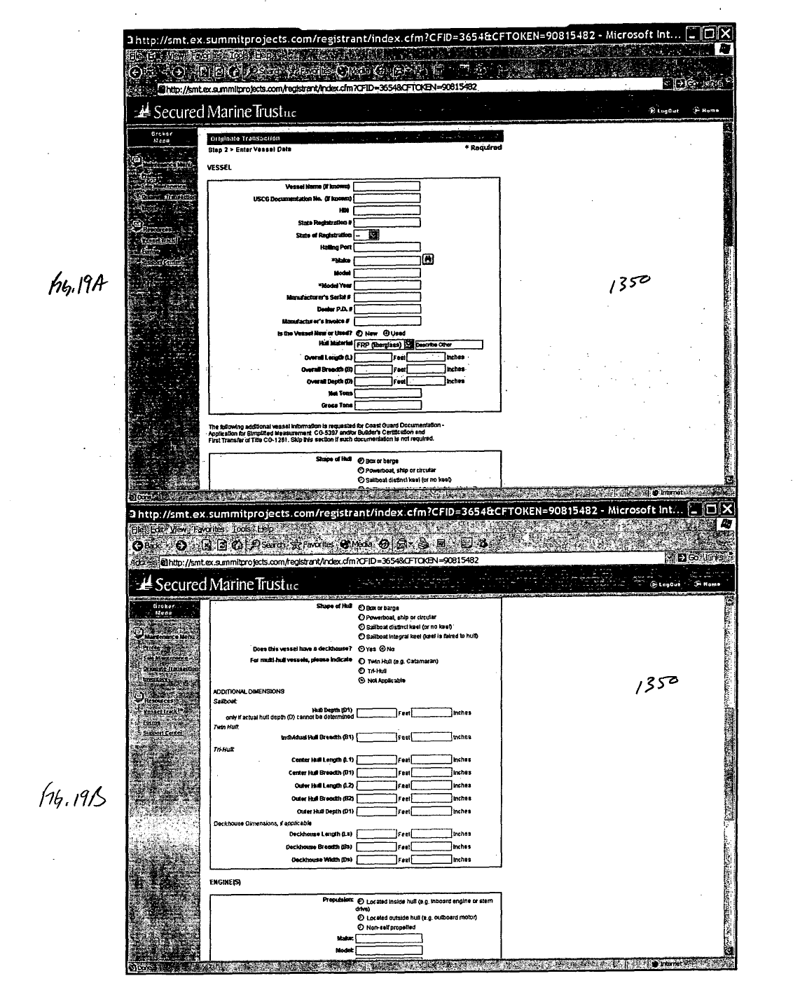

FIGS. 16A and 16B depict one embodiment of a user interface 1200 displaying a Generate Document functionality. The Generate Document functionality is a document management tool from which constituents to a transaction can view and print pertinent documents 1202 required for the transaction (e.g., purchase and sale agreements, escrow agreements, mortgage documents, vessel bills of sale, etc.). The SMT™ system 10 provides an efficient, one time data entry point for information related to a transaction and components thereof, and automatically distributes that data (via the Generate Documents function) to fields of documents 1202 required to complete the transaction.

### Originate Transaction.

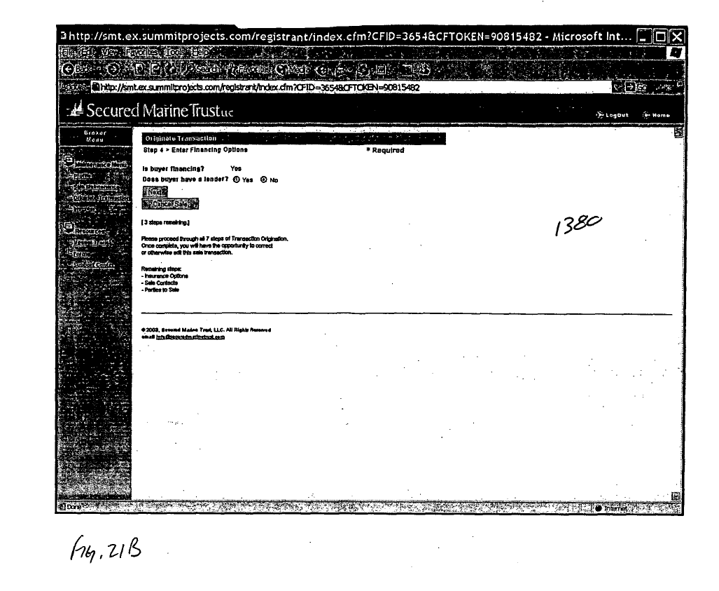

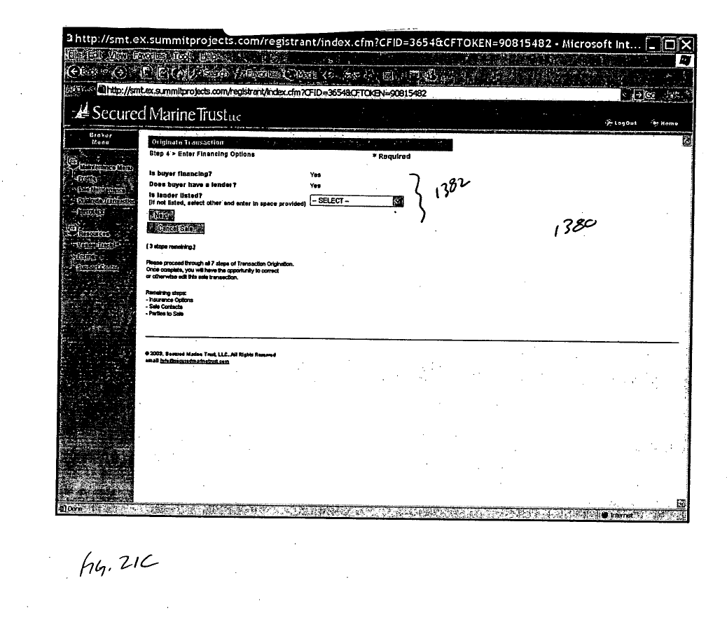

FIGS. 18A to 24I depict one embodiment of user interfaces 1300, 1350, 1360, 1380, 1390, 1400 and 1410, implementing the Originate Transaction functionality. The Originate Transaction functionality provides an initiation point for transactions into the SMT™ system 10. Generally speaking, a broker/dealer or manufacturer invokes the functionality to enter all data related to a specific transaction (e.g., vessel, sale data, buyer, seller, lender, brokers, etc.) Once the transaction is originated, the SMT™ system 10 assigns a unique transaction code to the transaction record and manages the transaction through specified milestones (e.g., creation and completion of activities and documents related thereto) concluding with a closing.

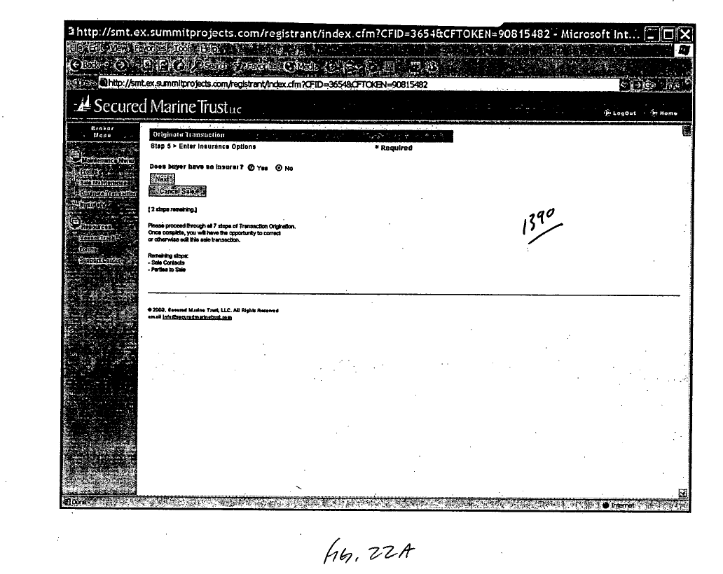

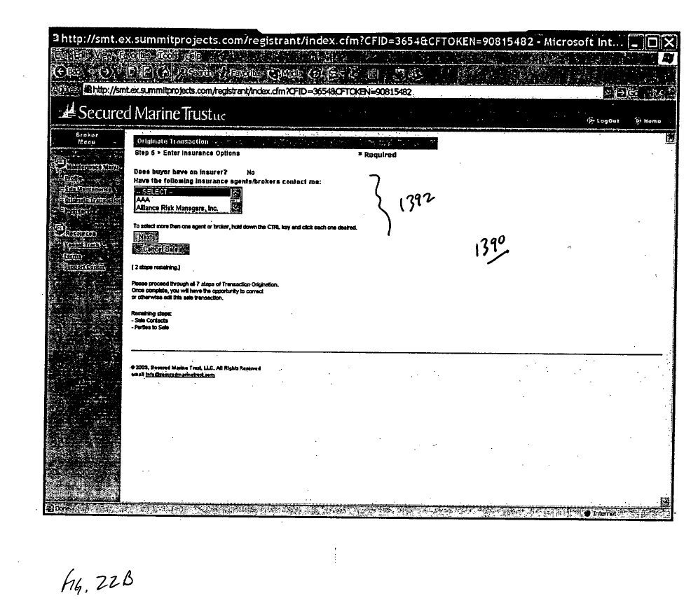

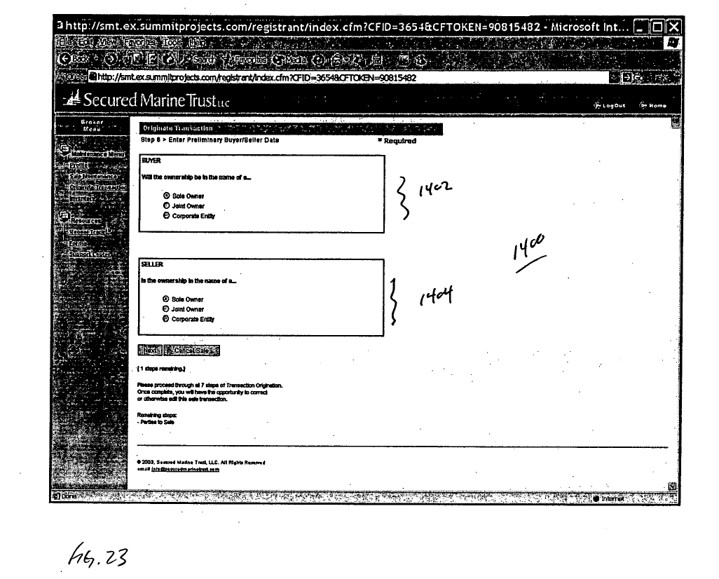

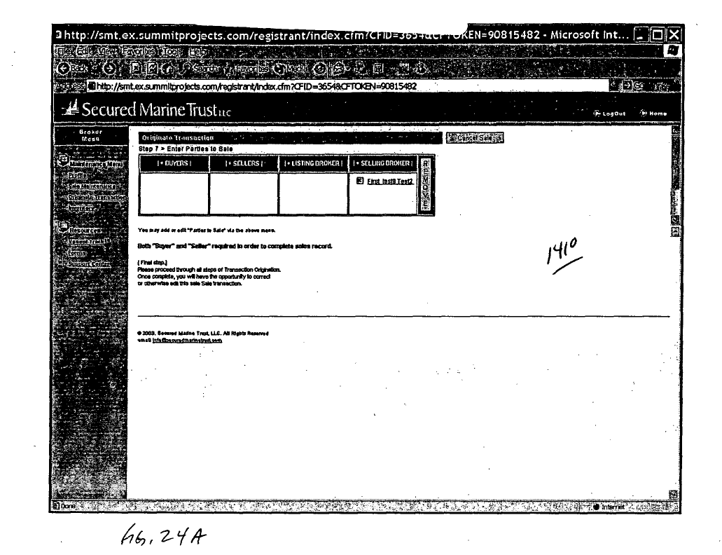

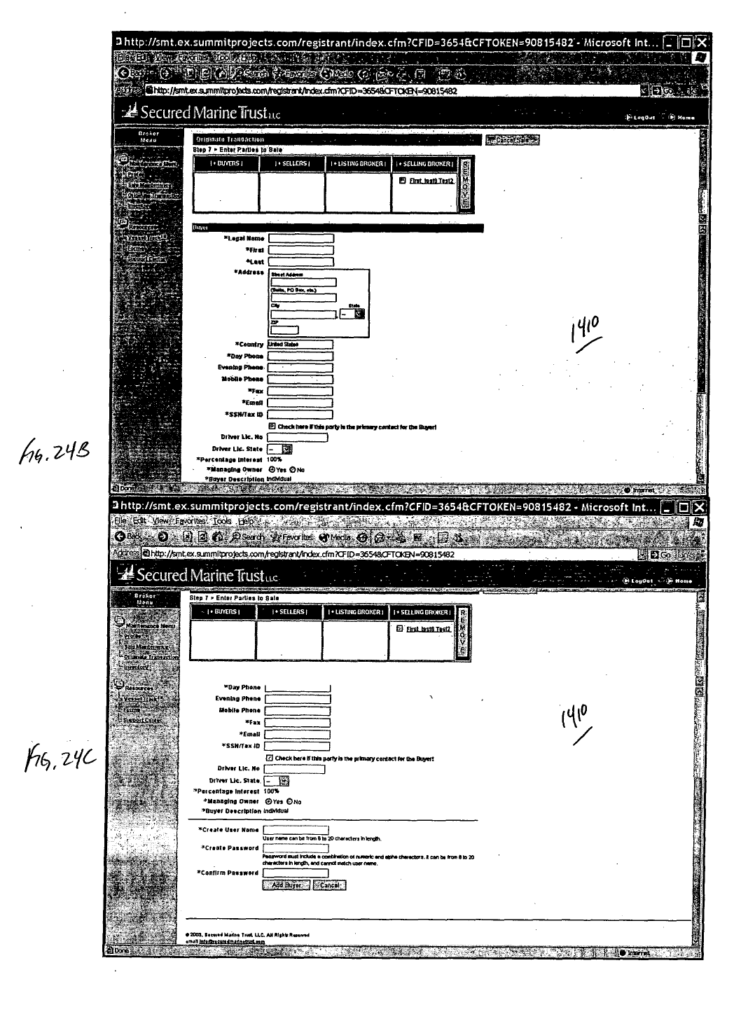

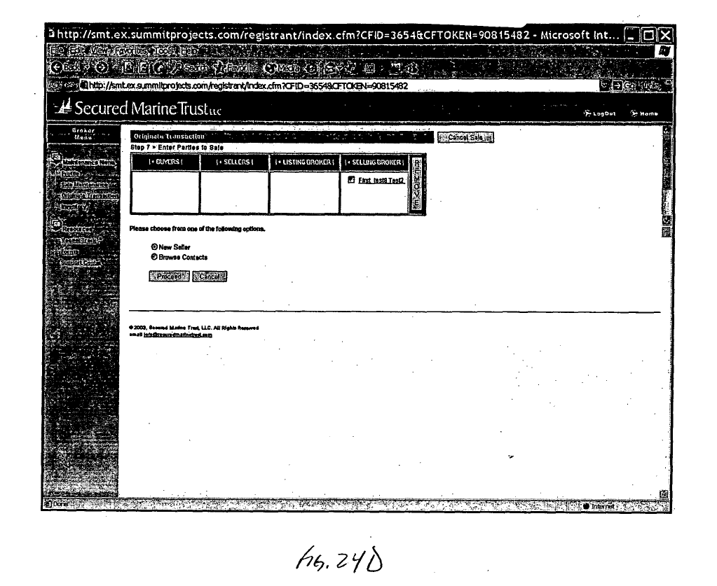

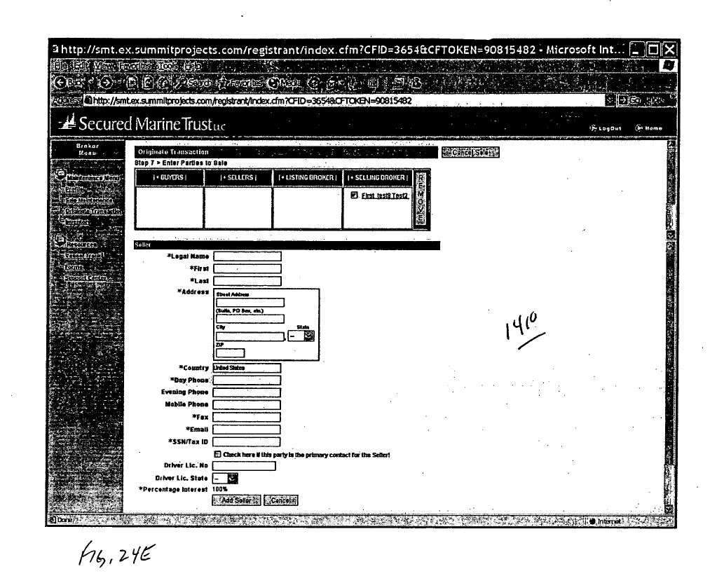

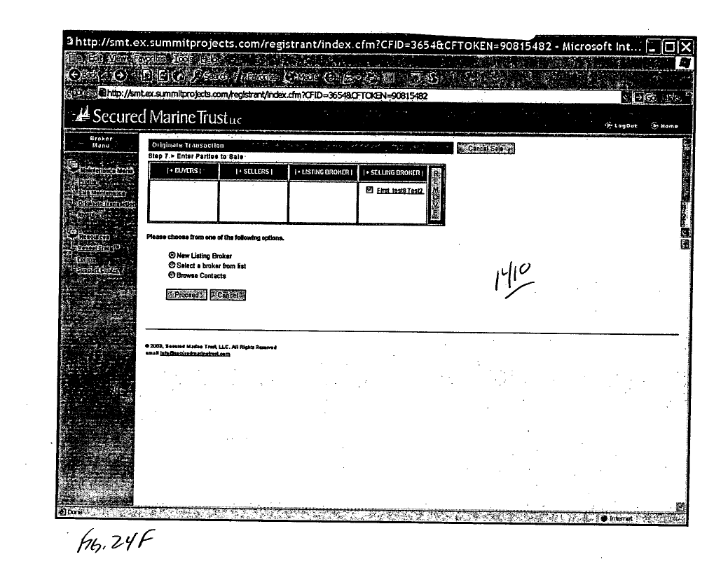

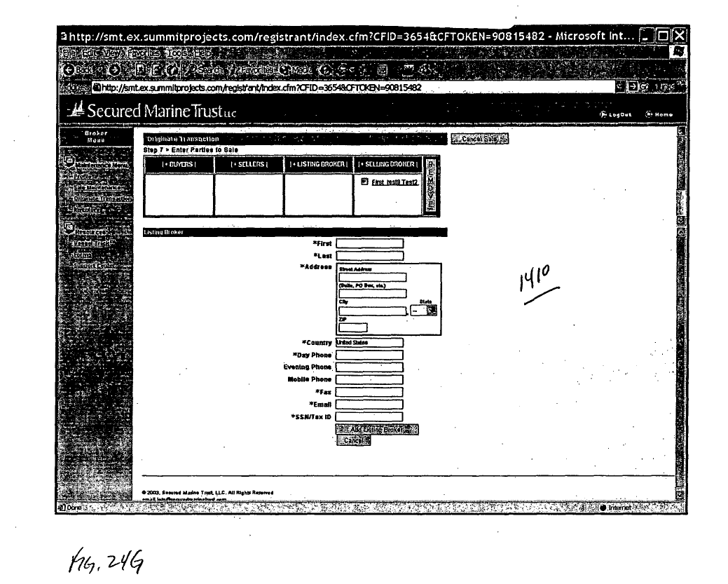

In one embodiment, the Originate Transaction functionality includes a multi-step process (e.g., a seven step process) by which a broker/dealer initiates and defines a transaction involving an object of value. For example, in a first step of the process, illustrated in FIGS. 18A and 18B, an interface 1300 assists the broker/dealer selected required services at 1310 and define the basic object information at 1320 (e.g., the vessel hull identification number (HIN)). A second step, illustrated in FIGS. 19A-19C, an interface 1350, assists the broker/dealer define details regarding the object. In a third step (FIG. 20), an interface 1360 allows the broker/dealer to enter sales data 1365, surveyor data 1370 and closing information 1375. At a step fourth step (FIGS. 21A-21C) an interface 1380 assists the dealer in defining financing information (e.g., buyer and lender financing 1382) relating to the transaction. At a fifth step (FIGS. 22A and 22B) an interface 1390 assists the dealer define whether the buyer has an insurer and, if not, provides a mechanism 1392 to initiate contact from an insurer or agent. In one embodiment, the mechanism 1392 is link to the email management module 238 (FIG. 2) which is invoked such that the SMT™ system 10 provides an electronic message to an insurer or agent registered with the system to contact the buyer and/or broker. At a sixth step (FIG. 23) an interface 1400 assists the dealer in entering buyer and seller information at 1402 and 1404, respectively. At a seventh step (FIGS. 24A-240) an interface 1410 provides the dealer an opportunity to enter data related to the parties to the transaction.

### Milestone Notification.

As described herein, the SMT™ system 10 monitors and provides visibility to transactions from a number of perspectives such that information of interest to the constituents is available upon request. The SMT™ system 10 is a repository of data and provides features and functions for storing, tracking and monitoring transactions and the activities performed and documentation created, reviewed and completed by parties to the transaction (e.g., the milestones) included therein. In one embodiment, illustrated in FIG. 1, notification messages 56 such as, for example, email messages or electronically generated and hand distributed (e.g., mailed) notices, of milestones of interest to one or more constituents are automatically generated and distributed to the constituents upon occurrence of the milestone. For example, the SMT™ system 10 triggers distribution of one or more of the following notification messages:
1. WARRANTY TRIGGER^{SM} an advanced notification for both new and aftermarket boat warranty registration that is provided to Manufacturers/Builders upon the occurrence of a completed transaction (e.g., sale);
2. LOAN CLOSE TRIGGER^{SM} an alert to an existing mortgagee when specific milestones in a transaction are reached. For example, alerts occur at a purchase initiation and at closing with closing details and contact information for payoff;
3. NEW LOAN TRIGGER^{SM} an alert sent when a purchase and sale agreement has been consummated and a buyer has identified a mortgagee for new loan. The SMT™ system 10 automatically notifies the selected mortgagee for new loan origination; and
4. RETAIL SALES TRIGGER^{SM} an email notification forwarded at both retail deposit stage and closing stage, alerting lender of these milestones. Advanced notice may provide an opportunity to manage and direct inbound pay-downs.

WARRANTY TRIGGER, LOAN CLOSE TRIGGER, NEW LOAN TRIGGER and RETAIL SALES TRIGGER are service marks of Secured Marine Trust, LLC, New Haven, Conn.

Although described in the context of preferred embodiments, it should be realized that a number of modifications to these teachings may occur to one skilled in the art. By example, the teachings of this invention are not intended to be limited to any specific application, that is, the invention is not intended to be utilized as only a system for monitoring transactions involving yachts, boats, ships, marine vessels and other means for transportation by water . It should be appreciated that the present invention may be used for monitoring and tracking any object of value such as, for example, a yacht, boat, ship, marine vessel, aircraft, motor vehicle, other transportation vehicles and equipment used therein and real estate for personal, commercial and/or recreational use or the like.

While the invention has been particularly shown and described with respect to preferred embodiments thereof, it will be understood by those skilled in the art that changes in form and details may be made therein without departing from the scope and spirit of the invention.

1. A system for tracking and monitoring activities related to a sales transaction for an object of value, the system comprising:
at least one client device operable by at least one of a plurality of users of the system;
at least one centralized data store for storing information that includes data identifying the object of value, the plurality of users of the system, activities related to the sales transaction and a plurality of documents for completing the sales transaction; and
a controller, operatively coupling the at least one client device and the at least one centralized data store, the controller selectively providing access to information stored in the data store for tracking and monitoring the activities performed and documents created, reviewed and completed by parties to the sales transaction, said access being provided via
a first user interlace providing information for monitoring a status of the sales transaction and deadlines pertaining to the sales transaction,
a second user interface providing access to a database including information from a third part regarding the object, and a third user interface providing descriptions of the documents for completing the sales transaction,
wherein a single entry of data relating to the sales transaction, performed using said client device, is effective to distribute said data to specified fields of the plurality of documents.

2. The system of claim 1 wherein the object of value is comprised of one of a yacht, boat, ship, marine vessel, aircraft, motor vehicle, other transportation vehicles and real estate for personal, commercial and/or recreational use.

3. The system of claim 1, wherein said user interfaces provide a graphical representation of the sales transaction and the plurality of activities and documents.

4. The system of claim 3, wherein the graphical representation further includes information regarding a current status of the activities and documents.

5. The system of claim 4, wherein the current status includes one of pending, closed, and aborted.

6. The system of claim 1, wherein the controller further includes a notification engine providing messages to the parties to the sales transaction corresponding to the activities and documents of the transaction.

7. The system of claim 1, further including an interface between the controller and an external data source including information related to the object of value.

8. The system of claim 1 wherein the plurality of users includes at least one of a dealer or broker, an escrow agent, a documentation agent, a buyer or seller of the object, a manufacturer or builder of the object, a wholesale finance or floor plan provider, a retail bank or financial institution, an insurance underwriter; agent or broker, a marine surveyor and a system administrator or closing coordinator.

9. The system of claim 7 wherein said external data source is searchable.

10. The system of claim 9 wherein said information is necessary to complete said sales transaction.

11. The system of claim 1 wherein said data store is a repository of data and has archival and retrieval functionality.

12. A system for tracking and monitoring activities related to a sales transaction for an object of value, the system comprising:
at least one client device operable by at least one of a plurality of users of the system;
at least one centralized data store for storing information that includes data identifying the object of value, the plurality of users of the system, activities related to the sales transaction and documents for completing the sales transaction;
a controller, operatively coupling the at least one client device and the at least one centralized data store, the controller selectively providing access to information stored in the data store for tracking and monitoring the activities performed and documents created, reviewed and completed by parties to the sales transaction; and
a user interface providing access to a database having information from a third party, said information including registration information from a government agency regarding the object.

13. The system of claim 12 wherein the object of value is comprised of a marine vessel.

14. The system of claim 12 wherein said registration information comprises official information maintained by the U.S. Coast Guard.

15. The system of claim 12 wherein said registration information is necessary to complete said sales transaction.
